(19) United States
(12) Patent Application Publication
(10) Pub. No.: US 2022/0264641 A1
(43) Pub. Date: Aug. 18, 2022

(54) HYBRID AUTOMATIC REPEAT REQUEST FEEDBACK METHOD AND APPARATUS

(71) Applicant: HUAWEI TECHNOLOGIES CO., LTD., Shenzhen (CN)

(72) Inventors: Qiong JIA, Shanghai (CN); Jiayin ZHANG, Shanghai (CN); Ji WU, Shanghai (CN)

(21) Appl. No.: 17/733,246

(22) Filed: Apr. 29, 2022

Related U.S. Application Data
(63) Continuation of application No. PCT/CN2019/114875, filed on Oct. 31, 2019.

(51) Int. Cl. H04W 74/08; H04L 1/18

(52) U.S. Cl. CPC H04W 74/0808; H04L 1/1812

(57) ABSTRACT

Embodiments provide a HARQ feedback method and apparatus, to resolve a current-technology problem that subsequent transmission is affected because a terminal device cannot provide a HARQ feedback in time due to uncertainty of LBT. The method includes: A first terminal device performs LBT, and sends HARQ information of a plurality of second terminal devices on a channel resource on which the LBT succeeds, so that for different second terminal devices, the first terminal device does not perform LBT for a plurality of times, thereby reducing LBT overheads, and overcoming a problem that HARQ information corresponding to some second terminal devices cannot be sent in time due to an LBT failure.

### CROSS-REFERENCE TO RELATED APPLICATIONS

This application is a continuation of International Application No. PCT/CN2019/114875, filed on Oct. 31, 2019. The disclosures of the aforementioned application is hereby incorporated by reference in its entirety.

### BACKGROUND

Long term evolution (long term evolution, LTE) starts to support device-to-device (device-to-device, D2D) communication or sidelink communication (sidelink communication) in a cellular network since GPP Release 12. A D2D communication technology refers to a communication mode in which two peer-to-peer user nodes directly communicate. Based on frequency bands in which D2D technologies are operated, the D2D technologies are classified into a D2D technology that is operated in a licensed frequency band and a D2D technology that is operated in an unlicensed frequency band.

A communication system deployed in an unlicensed spectrum usually uses/shares an unlicensed resource in a contention manner. Usually, before sending a signal, a station first listens to whether the unlicensed spectrum is idle, for example, determining a busy/idle state of the unlicensed spectrum based on a magnitude of a receive power in the unlicensed spectrum. If the receive power is less than a particular threshold, it is considered that the unlicensed spectrum is in the idle state, and the signal is sent in the unlicensed spectrum. If the receive power is not less than a particular threshold, the signal is not sent. This listen before talk mechanism is referred to as listen before talk (listen before talk, LBT).

In the licensed frequency band, there is a fixed time relationship between a physical sidelink shared channel (physical sidelink shared channel, PSSCH) and a physical sidelink feedback channel (physical SL feedback channel, PSFCH) for sending a HARQ feedback corresponding to the physical sidelink shared channel, so that a terminal device provides the HARQ feedback for the PSSCH on the PSFCH. However, in the unlicensed frequency band, the terminal device performs LBT on the PSFCH before providing the HARQ feedback for the PSSCH on the PSFCH. Due to uncertainty of LBT, the terminal device does not provide a HARQ feedback in time, affecting subsequent transmission.

### SUMMARY

Embodiments provide a HARQ feedback method and apparatus, to resolve a current-technology problem that subsequent transmission is affected because a terminal device cannot provide a HARQ feedback in time due to uncertainty of LBT.

According to a first aspect, an embodiment provides a HARQ feedback method. The method includes: A first terminal device performs LBT; and after the LBT succeeds, the first terminal device sends HARQ information of a plurality of second terminal devices on a channel resource on which the LBT succeeds. In this embodiment, the first terminal device includes the HARQ information of the plurality of second terminal devices on one PSFCH. For different second terminal devices, the LBT is not performed for a plurality of times, thereby reducing LBT overheads, and overcoming a problem that HARQ information corresponding to some second terminal devices cannot be sent in time due to an LBT failure.

In at least one embodiment, any second terminal device has a plurality of HARQ processes, and HARQ information of the second terminal device includes feedback information corresponding to the plurality of HARQ processes. The feedback information of the plurality of HARQ processes is sent, so that the second terminal device resends data based on a granularity of HARQ process, thereby improving resource utilization.

In at least one embodiment, the first terminal device sends an identifier of the first terminal device to the plurality of second terminal devices. The second terminal device determines an information source, so that accuracy of resending data by the second terminal device is improved.

In at least one embodiment, the first terminal device sends HARQ information of a plurality of second terminal devices on a channel resource on which the LBT succeeds includes: The first terminal device sends the HARQ information of the plurality of second terminal devices on a feedback channel on which the LBT succeeds, where a correspondence exists between the feedback channel and the first terminal device. The first terminal device sends the HARQ information of the plurality of second terminal devices on the corresponding feedback channel, so that the second terminal device determines the information source based on the feedback channel for receiving the HARQ information, thereby improving the accuracy of resending data by the second terminal device.

In at least one embodiment, the feedback channel is determined based on the identifier of the first terminal device. The second terminal device determines the identifier based on the feedback channel for receiving the HARQ information, to determine, based on the identifier, a terminal device that sends the HARQ information. Thus, the accuracy of resending data by the second terminal device is improved.

In at least one embodiment, the first terminal device and the plurality of second terminal devices are located in a same terminal device group, and the identifier of the first terminal device includes one or more of the following identifiers: an identifier of the terminal device group, an identifier of the first terminal device in the terminal device group, or a source node identifier (source ID) of the first terminal device. The identifier of the terminal device group and the identifier of the first terminal device in the terminal device group occupies fewer information bits. Thus, overheads are reduced.

In at least one embodiment, the identifier of the first terminal device includes a source ID of the first terminal device. The source ID identifies a terminal device, so that the second terminal device determines the terminal device that sends the HARQ information, thereby improving the accuracy of resending data by the second terminal device.

In at least one embodiment, after the first terminal device sends the HARQ information of the plurality of second terminal devices on the channel resource on which the LBT succeeds, the first terminal device receives indication information sent by the second terminal device, where the indication information indicates whether at least one terminal device including the first terminal device resends the HARQ information. The first terminal device resends the HARQ information to the second terminal device when the indication information indicates to the first terminal device to resend the HARQ information. The first terminal device determines, based on the indication of the second terminal device, whether to resend the HARQ information, so that some system overheads are avoided, and resource utilization is improved.

According to a second aspect, an embodiment provides a HARQ feedback method. The method includes: a second terminal device detects, on a channel resource, feedback information sent by a first terminal device, where the feedback information includes HARQ information of a plurality of terminal devices including the second terminal device; and the second terminal device determines, based on the feedback information, HARQ information corresponding to the second terminal device.

In at least one embodiment, the second terminal device has a plurality of HARQ processes, and the HARQ information of the second terminal device includes feedback information corresponding to the plurality of HARQ processes. The feedback information of the plurality of HARQ processes is sent, so that the second terminal device resends data based on a granularity of HARQ process, thereby improving resource utilization.

In at least one embodiment, the second terminal device receives an identifier of the first terminal device. The second terminal device determines an information source, so that accuracy of resending data by the second terminal device is improved.

In at least one embodiment, the channel resource is a feedback channel corresponding to the first terminal device. The first terminal device sends the HARQ information of the plurality of second terminal devices on the corresponding feedback channel, so that the second terminal device determines the information source based on the feedback channel for receiving the HARQ information, thereby improving the accuracy of resending data by the second terminal device.

In at least one embodiment, the feedback channel is determined based on the identifier of the first terminal device. The second terminal device determines the identifier based on the feedback channel for receiving the HARQ information, to determine, based on the identifier, a terminal device that sends the HARQ information. Thus, the accuracy of resending data by the second terminal device is improved.

In at least one embodiment, the first terminal device and the plurality of second terminal devices are located in a same terminal device group, and the identifier of the first terminal device includes one or more of the following identifiers: an identifier of the terminal device group, an identifier of the first terminal device in the terminal device group, or a source ID of the first terminal device. The identifier of the terminal device group and the identifier of the first terminal device in the terminal device group occupies fewer information bits. Thus, system overheads are reduced.

In at least one embodiment, the identifier of the first terminal device includes a source ID of the first terminal device. The source ID identifies a terminal device, so that the second terminal device determines the terminal device that sends the HARQ information, thereby improving the accuracy of resending data by the second terminal device.

In at least one embodiment, after the second terminal device detects, on the channel resource, the feedback information sent by the first terminal device, the second terminal device determines indication information, where the indication information indicates whether the at least one first terminal device resends the HARQ information; and the second terminal device sends the indication information. The first terminal device determines, based on the indication of the second terminal device, whether to resend the HARQ information, so that some system overheads are avoided, and resource utilization are improved.

According to a third aspect, an embodiment provides a HARQ feedback method. The method includes: A first terminal device receives a PSSCH sent by a second terminal device; the first terminal device performs LBT on a plurality of feedback channels corresponding to the PSSCH; and the first terminal device sends HARQ information of the PSSCH to the second terminal device on one or more feedback channels on which the LBT succeeds. For a PSSCH in this embodiment, a receiving device that receives the PSSCH has a plurality of PSFCHs that carry HARQ information of the PSSCH. In this implementation, even if the first terminal device fails to perform LBT on a PSFCH, the HARQ information of the PSSCH is transmitted through another PSFCH corresponding to the PSSCH.

In at least one embodiment, the first terminal device sends sidelink control information (sidelink control information, SCI) to the second terminal device, or the first terminal device receives SCI sent by the second terminal device. The SCI carries indication information indicating that the HARQ information is newly fed back HARQ information, or the SCI carries indication information indicating that the HARQ information is retransmitted HARQ information. The first terminal device and the second terminal device have a unified understanding on the HARQ information, thereby improving communication reliability.

In at least one embodiment, the SCI further carries indication information indicating a size of the HARQ information. The first terminal device and the second terminal device transmits the HARQ information based on the indicated size, thereby improving communication reliability.

In at least one embodiment, a correspondence exists between the feedback channel and the first terminal device. The first terminal device sends the HARQ information on the corresponding feedback channel, so that the second terminal device determines an information source based on the feedback channel for receiving the HARQ information, thereby improving accuracy of resending data by the second terminal device.

In at least one embodiment, a feedback channel resource is determined based on an identifier of the first terminal device. The second terminal device determines the identifier based on the feedback channel for receiving the HARQ information, to determine, based on the identifier, a terminal device that sends the HARQ information. Thus, the accuracy of resending data by the second terminal device is improved.

In at least one embodiment, the first terminal device and a plurality of second terminal devices are located in a same terminal device group, and the identifier of the first terminal device includes one or more of the following identifiers: an identifier of the terminal device group, an identifier of the first terminal device in the terminal device group, or a source ID of the first terminal device. The identifier of the terminal device group and the identifier of the first terminal device in the terminal device group occupies fewer information bits. Thus, system overheads are reduced.

In at least one embodiment, the identifier of the first terminal device includes a source ID of the first terminal device. The source ID identifies a terminal device, so that the second terminal device can accurately determine the terminal device that sends the HARQ information, thereby improving the accuracy of resending data by the second terminal device.

In at least one embodiment, after the first terminal device sends the HARQ information of the PSSCH to the second terminal device on the one or more feedback channels on which the LBT succeeds, the first terminal device receives first indication information sent by the second terminal device. The first indication information indicates whether at least one terminal device including the first terminal device resends the HARQ information. The first terminal device resends the HARQ information to the second terminal device when the first indication information indicates the first terminal device to resend the HARQ information. The first terminal device determines, based on the indication of the second terminal device, whether to resend the HARQ information, so that some system overheads are avoided, and resource utilization is improved.

According to a fourth aspect, an embodiment provides a HARQ feedback method. The method includes: A second terminal device sends a PSSCH to a first terminal device; and the second terminal device detects, on a plurality of feedback channels corresponding to the PSSCH, HARQ information sent by the first terminal device. For a PSSCH in this embodiment, a receiving device that receives the PSSCH has a plurality of PSFCHs that carry HARQ information of the PSSCH. In this implementation, even if the first terminal device fails to perform LBT on a PSFCH, the HARQ information of the PSSCH is transmitted through another PSFCH corresponding to the PSSCH.

In at least one embodiment, the second terminal device receives SCI sent by the first terminal device, or the second terminal device sends SCI to the first terminal device. The SCI carries indication information indicating that the HARQ information is newly fed back HARQ information, or the SCI carries indication information indicating that the HARQ information is retransmitted HARQ information. The first terminal device and the second terminal device have a unified understanding on the HARQ information, thereby improving communication reliability.

In at least one embodiment, the SCI further carries indication information indicating a size of the HARQ information. The first terminal device and the second terminal device transmits the HARQ information based on the indicated size, thereby improving communication reliability.

In at least one embodiment, a correspondence exists between the feedback channel and the first terminal device. The first terminal device sends the HARQ information on the corresponding feedback channel, so that the second terminal device determines an information source based on the feedback channel for receiving the HARQ information, thereby improving accuracy of resending data by the second terminal device.

In at least one embodiment, the second terminal device determines the feedback channel based on an identifier of the first terminal device. The second terminal device determines the identifier based on the feedback channel for receiving the HARQ information, to determine, based on the identifier, a terminal device that sends the HARQ information. Thus, the accuracy of resending data by the second terminal device is improved.

In at least one embodiment, the first terminal device and a plurality of second terminal devices are located in a same terminal device group, and the identifier of the first terminal device includes one or more of the following identifiers: an identifier of the terminal device group, an identifier of the first terminal device in the terminal device group, or a source ID of the first terminal device. The identifier of the terminal device group and the identifier of the first terminal device in the terminal device group occupies fewer information bits. Thus, system overheads are reduced.

In at least one embodiment, the identifier of the first terminal device includes a source ID of the first terminal device. The source ID identifies a terminal device, so that the second terminal device accurately determines the terminal device that sends the HARQ information, thereby improving the accuracy of resending data by the second terminal device.

In at least one embodiment, after the second terminal device detects, on the plurality of feedback channels corresponding to the PSSCH, the HARQ information sent by the first terminal device, the second terminal device determines first indication information, where the first indication information indicates whether at least one first terminal device resends the HARQ information; and the second terminal device sends the first indication information. The first terminal device determines, based on the indication of the second terminal device, whether to resend the HARQ information, so that some system overheads are avoided, and resource utilization is improved.

According to a fifth aspect, an embodiment provides a HARQ feedback method. The method includes: A first terminal device receives first indication information sent by a second terminal device, where the first indication information indicates whether at least one terminal device including the first terminal device resends HARQ information; and the first terminal device resends the HARQ information to the second terminal device when the first indication information indicates the first terminal device to resend the HARQ information. In this embodiment, because the second terminal device corresponds to one or more potential first terminal devices, the first indication information sent by the second terminal device indicates whether a plurality of first terminal devices resends HARQ information. On the one hand, a problem that HARQ information corresponding to some second terminal devices cannot be sent in time due to an LBT failure is overcome, and on the other hand, system overheads are further reduced.

In at least one embodiment, the first indication information indicates to resend the HARQ information, or the first indication information indicates that the HARQ information is not to be resent. In the foregoing design, first terminal devices are not distinguished for the first indication information, and the first indication information is valid for the plurality of first terminal devices, so that system overheads are reduced.

In at least one embodiment, the first indication information indicates, by using a bitmap (bitmap), whether the at least one terminal device resends the HARQ information; the first indication information indicates, by using a status value, a terminal device that resends HARQ information; or the first indication information indicates, by using a status value, a terminal device that does not resend the HARQ information. The first indication information indicates corresponding information for different first terminal devices, so that indication precision of the first indication information is improved, and the first terminal device determines, based on the corresponding information, whether the HARQ information is to be resent. Thus, communication reliability is improved.

In at least one embodiment, the first terminal device receives second indication information sent by the second terminal device, where the second indication information indicates whether the at least one terminal device is to combine and send HARQ information that is not successfully sent and HARQ information that is to be sent next time. The second terminal device indicates a manner in which the first terminal device resends the HARQ information, so that the first terminal device and the second terminal device transmits the resent HARQ information in the manner.

In at least one embodiment, the second indication information is unrelated to an identifier of the at least one terminal device. The second indication information indicates that the HARQ information that is not successfully sent and the HARQ information that is to be sent next time are to be combined and sent, or the second indication information indicates that the HARQ information that is not successfully sent and the HARQ information that is to be sent next time are not to be combined and sent. In the foregoing design, terminal devices are not distinguished for the second indication information, and the second indication information is valid for a plurality of terminal devices, so that system overheads are reduced.

In at least one embodiment, the second indication information is related to an identifier of the at least one terminal device. The second indication information indicates, by using a bitmap, whether the at least one terminal device is to combine and send the HARQ information that is not successfully sent and the HARQ information that is to be sent next time; the second indication information indicates, by using a status value, a terminal device that is to combine and send the HARQ information that is not successfully sent and the HARQ information that is to be sent next time; or the second indication information indicates, by using a status value, a terminal device that does not combine and send the HARQ information that is not successfully sent and the HARQ information that is to be sent next time. The second indication information indicates corresponding information for different terminal devices, so that indication precision of the second indication information is improved, and the terminal device determines, based on the corresponding information, a manner of resending the HARQ information. Thus, communication reliability is improved.

In at least one embodiment, the second indication information further indicates PSSCH information corresponding to HARQ information that is to be combined and sent. Alternatively, the second indication information further indicates HARQ process information corresponding to HARQ information that is to be combined and sent. The PSSCH information or the HARQ process information is indicated, so that the first terminal device resends data based on the indicated PSSCH information or the indicated HARQ process information, thereby improving communication reliability.

In at least one embodiment, when the first terminal device resends the HARQ information to the second terminal device, the first terminal device combines and send the HARQ information that is not successfully sent and the HARQ information that is to be sent next time. In the foregoing manner, the HARQ information that is not successfully sent and the HARQ information that is to be sent next time are combined and sent, so that system overheads are reduced.

In at least one embodiment, the at least one terminal device and the second terminal device belongs to a same terminal device group. The second terminal device sends the second indication information to terminal devices in a same terminal device group, to improve communication reliability.

According to a sixth aspect, an embodiment provides a HARQ feedback method. The method includes: A second terminal device determines first indication information, where the first indication information indicates whether at least one first terminal device is to resend HARQ information; and the second terminal device sends the first indication information. In this embodiment, because the second terminal device corresponds to one or more potential first terminal devices, the first indication information sent by the second terminal device indicates whether a plurality of first terminal devices is to resend HARQ information. On the one hand, a problem that HARQ information corresponding to some second terminal devices cannot be sent in time due to an LBT failure is overcome, and on the other hand, system overheads are further reduced.

In at least one embodiment, the first indication information is unrelated to an identifier of the at least one first terminal device. The first indication information indicates to resend the HARQ information, or the first indication information indicates that the HARQ information is not to be resent. In the foregoing design, first terminal devices are not distinguished for the first indication information, and the first indication information is valid for the plurality of first terminal devices, so that system overheads are reduced.

In at least one embodiment, the first indication information is related to an identifier of the at least one first terminal device. The first indication information indicates, by using a bitmap, whether the at least one first terminal device is to resend the HARQ information; the first indication information indicates, by using a status value, a first terminal device that is to resend the HARQ information; or the first indication information indicates, by using a status value, a first terminal device that does resend the HARQ information. The first indication information indicates corresponding information for different first terminal devices, so that indication precision of the first indication information is improved, and the first terminal device determines, based on the corresponding information, whether the HARQ information is to be resent. Thus, communication reliability is improved.

In at least one embodiment, the second terminal device sends second indication information, where the second indication information indicates whether the at least one first terminal device is to combine and send HARQ information that is not successfully sent and HARQ information that is to be sent next time. The second terminal device indicates a manner in which the first terminal device resends the HARQ information, so that the first terminal device and the second terminal device transmits the resent HARQ information in the manner.

In at least one embodiment, the second indication information is unrelated to the identifier of the at least one terminal device. The second indication information indicates that the HARQ information that is not successfully sent and the HARQ information that is to be sent next time is to be combined and sent, or the second indication information indicates that the HARQ information that is not successfully sent and the HARQ information that is to be sent next time are not to be combined and sent. In the foregoing design, terminal devices are not distinguished for the second indication information, and the second indication information is valid for a plurality of terminal devices, so that system overheads are reduced.

In at least one embodiment, the second indication information is related to the identifier of the at least one terminal device. The second indication information indicates, by using a bitmap, whether the at least one terminal device is to combine and send the HARQ information that is not successfully sent and the HARQ information that is to be sent next time; the second indication information indicates, by using a status value, a terminal device that is to combine and send the HARQ information that is not successfully sent and the HARQ information that is to be sent next time; or the second indication information indicates, by using a status value, a terminal device that does not combine and send the HARQ information that is not successfully sent and the HARQ information that is to be sent next time. The second indication information indicates corresponding information for different terminal devices, so that indication precision of the second indication information is improved, and the terminal device determines, based on the corresponding information, a manner of resending the HARQ information. Thus, communication reliability is improved.

In at least one embodiment, the second indication information further indicates PSSCH information corresponding to HARQ information that is to be combined and sent. Alternatively, the second indication information further indicates HARQ process information corresponding to HARQ information that is to be combined and sent. The PSSCH information or the HARQ process information is indicated, so that the first terminal device resends data based on the indicated PSSCH information or the indicated HARQ process information, thereby improving communication reliability.

In at least one embodiment, the at least one first terminal device and the second terminal device belong to a same terminal device group. The second terminal device sends the second indication information to terminal devices in a same terminal device group, to improve communication reliability.

According to a seventh aspect, an embodiment provides a HARQ feedback apparatus. The apparatus includes: a processor, configured to perform LBT; and a communication module, configured to: after the LBT succeeds, send HARQ information of a plurality of second terminal devices on a channel resource on which the LBT succeeds.

In at least one embodiment, any second terminal device has a plurality of HARQ processes, and HARQ information of the second terminal device includes feedback information corresponding to the plurality of HARQ processes.

In at least one embodiment, the communication module is further configured to send an identifier of a first terminal device to the plurality of second terminal devices.

In at least one embodiment, when sending the HARQ information of the plurality of second terminal devices on the channel resource on which the LBT succeeds, the communication module is configured to send the HARQ information for the plurality of second terminal devices on a feedback channel on which the LBT succeeds, where a correspondence exists between the feedback channel and the first terminal device.

In at least one embodiment, the feedback channel is determined based on the identifier of the first terminal device.

In at least one embodiment, the first terminal device and the plurality of second terminal devices are located in a same terminal device group, and the identifier of the first terminal device includes one or more of the following identifiers: an identifier of the terminal device group, an identifier of the first terminal device in the terminal device group, or a source ID of the first terminal device.

In at least one embodiment, the identifier of the first terminal device includes a source ID of the first terminal device.

In at least one embodiment, the communication module is further configured to: after sending the HARQ information of the plurality of second terminal devices on the channel resource on which the LBT succeeds, receive indication information sent by the second terminal device, where the indication information indicates whether at least one terminal device including the first terminal device is to resend the HARQ information; and resend the HARQ information to the second terminal device when the indication information indicates the first terminal device to resend the HARQ information.

In at least one embodiment, the communication module includes an interface or a transceiver.

In at least one embodiment, the apparatus is a chip.

In at least one embodiment, the apparatus is a terminal device

According to an eighth aspect, an embodiment provides a HARQ feedback apparatus. The apparatus includes: a communication module, configured to detect, on a channel resource, feedback information sent by a first terminal device, where the feedback information includes HARQ information of a plurality of terminal devices including a second terminal device; and a processor, configured to determine, based on the feedback information, HARQ information corresponding to the second terminal device.

In at least one embodiment, the second terminal device has a plurality of HARQ processes, and the HARQ information of the second terminal device includes feedback information corresponding to the plurality of HARQ processes.

In at least one embodiment, the communication module is further configured to receive an identifier of the first terminal device.

In at least one embodiment, the channel resource is a feedback channel corresponding to the first terminal device.

In at least one embodiment, the feedback channel is determined based on the identifier of the first terminal device.

In at least one embodiment, the first terminal device and the plurality of second terminal devices are located in a same terminal device group, and the identifier of the first terminal device includes one or more of the following identifiers: an identifier of the terminal device group, an identifier of the first terminal device in the terminal device group, or a source ID of the first terminal device.

In at least one embodiment, the identifier of the first terminal device includes a source ID of the first terminal device.

In at least one embodiment, the processor is further configured to: after the communication module detects, on the channel resource, the feedback information sent by the first terminal device, determine indication information, where the indication information indicates whether the at least one first terminal device is to resend the HARQ information; and the communication module is further configured to send the indication information.

In at least one embodiment, the communication module includes an interface or a transceiver.

In at least one embodiment, the apparatus is a chip.

In at least one embodiment, the apparatus is a terminal device

According to a ninth aspect, an embodiment provides a HARQ feedback apparatus. The apparatus includes: a communication module, configured to receive a PSSCH sent by a second terminal device; and a processor, configured to perform LBT on a plurality of feedback channels corresponding to the PSSCH, where the communication module is further configured to send HARQ information of the PSSCH to the second terminal device on one or more feedback channels on which the LBT succeeds.

In at least one embodiment, the communication module is further configured to: send SCI to the second terminal device, or receive SCI sent by the second terminal device. The SCI carries indication information indicating that the HARQ information is newly fed back HARQ information, or the SCI carries indication information indicating that the HARQ information is retransmitted HARQ information.

In at least one embodiment, the SCI further carries indication information indicating a size of the HARQ information.

In at least one embodiment, a correspondence exists between a feedback channel and a first terminal device.

In at least one embodiment, a feedback channel resource is determined based on an identifier of the first terminal device.

In at least one embodiment, the first terminal device and a plurality of second terminal devices are located in a same terminal device group, and the identifier of the first terminal device includes one or more of the following identifiers: an identifier of the terminal device group, an identifier of the first terminal device in the terminal device group, or a source ID of the first terminal device.

In at least one embodiment, the identifier of the first terminal device includes a source ID of the first terminal device.

In at least one embodiment, the communication module is further configured to: after sending the HARQ information of the PSSCH to the second terminal device on the one or more feedback channels on which the LBT succeeds, receive first indication information sent by the second terminal device, where the first indication information indicates whether at least one terminal device including the first terminal device is to resend the HARQ information; and resend the HARQ information to the second terminal device when the first indication information indicates the first terminal device to resend the HARQ information.

In at least one embodiment, the communication module includes an interface or a transceiver.

In at least one embodiment, the apparatus is a chip.

In at least one embodiment, the apparatus is a terminal device

According to a tenth aspect, an embodiment provides a HARQ feedback apparatus. The apparatus includes: a communication module, configured to: send a PSSCH to a first terminal device; and detect, on a plurality of feedback channels corresponding to the PSSCH, HARQ information sent by the first terminal device.

In at least one embodiment, the communication module is further configured to: receive SCI sent by the first terminal device, or send SCI to the first terminal device. The SCI carries indication information indicating that the HARQ information is newly fed back HARQ information, or the SCI carries indication information indicating that the HARQ information is retransmitted HARQ information.

In at least one embodiment, the SCI further carries indication information indicating a size of the HARQ information.

In at least one embodiment, a correspondence exists between the feedback channel and the first terminal device.

In at least one embodiment, the apparatus further includes: a processor, configured to determine the feedback channel based on an identifier of the first terminal device.

In at least one embodiment, the first terminal device and a plurality of second terminal devices are located in a same terminal device group, and the identifier of the first terminal device includes one or more of the following identifiers: an identifier of the terminal device group, an identifier of the first terminal device in the terminal device group, or a source ID of the first terminal device.

In at least one embodiment, the identifier of the first terminal device includes a source ID of the first terminal device.

In at least one embodiment, the apparatus further includes: the processor, configured to: after the HARQ information sent by the first terminal device is detected on the plurality of feedback channels corresponding to the PSSCH, determine first indication information, where the first indication information indicates whether at least one first terminal device is to resend the HARQ information; and the communication module, further configured to send the first indication information.

In at least one embodiment, the communication module includes an interface or a transceiver.

In at least one embodiment, the apparatus is a chip.

In at least one embodiment, the apparatus is a terminal device

According to an eleventh aspect, an embodiment provides a HARQ feedback apparatus. The apparatus includes: a communication module, configured to: receive first indication information sent by a second terminal device, where the first indication information indicates whether at least one terminal device including a first terminal device is to resend HARQ information; and resend the HARQ information to the second terminal device when the first indication information indicates the first terminal device to resend the HARQ information.

In at least one embodiment, the first indication information indicates to resend the HARQ information, or the first indication information indicates that the HARQ information is not to be resent.

In at least one embodiment, the first indication information indicates, by using a bitmap, whether the at least one terminal device is to resend the HARQ information; the first indication information indicates, by using a status value, a terminal device that is to resend the HARQ information; or the first indication information indicates, by using a status value, a terminal device that is not to resend the HARQ information.

In at least one embodiment, the communication module is further configured to receive second indication information sent by the second terminal device, where the second indication information indicates whether the at least one terminal device is to combine and send HARQ information that is not successfully sent and HARQ information that is to be sent next time.

In at least one embodiment, the second indication information is unrelated to an identifier of the at least one terminal device. The second indication information indicates that the HARQ information that is not successfully sent and the HARQ information that is to be sent next time is to be combined and sent, or the second indication information indicates that the HARQ information that is not successfully sent and the HARQ information that is to be sent next time are not to be combined and sent.

In at least one embodiment, the second indication information is related to an identifier of the at least one terminal device. The second indication information indicates, by using a bitmap, whether the at least one terminal device is to combine and send the HARQ information that is not successfully sent and the HARQ information that is to be sent next time; the second indication information indicates, by using a status value, a terminal device that is to combine and send the HARQ information that is not successfully sent and the HARQ information that is to be sent next time; or the second indication information indicates, by using a status value, a terminal device that is not to combine and send the HARQ information that is not successfully sent and the HARQ information that is to be sent next time.

In at least one embodiment, the second indication information further indicates PSSCH information corresponding to HARQ information that is to be combined and sent. Alternatively, the second indication information further indicates HARQ process information corresponding to HARQ information that is to be combined and sent.

In at least one embodiment, when resending the HARQ information to the second terminal device, the communication module is configured to combine and send the HARQ information that is not successfully sent and the HARQ information that is to be sent next time.

In at least one embodiment, the at least one terminal device and the second terminal device belong to a same terminal device group.

In at least one embodiment, the communication module includes an interface or a transceiver.

In at least one embodiment, the apparatus is a chip.

In at least one embodiment, the apparatus is a terminal device

According to a twelfth aspect, an embodiment provides a HARQ feedback apparatus. The apparatus includes: a processor, configured to determine first indication information, where the first indication information indicates whether at least one first terminal device is to resend HARQ information; and a communication module, configured to send the first indication information.

In at least one embodiment, the first indication information is unrelated to an identifier of the at least one first terminal device. The first indication information indicates to resend the HARQ information, or the first indication information indicates that the HARQ information is not to be resent.

In at least one embodiment, the first indication information is related to an identifier of the at least one first terminal device. The first indication information indicates, by using a bitmap, whether the at least one first terminal device is to resend the HARQ information; the first indication information indicates, by using a status value, a first terminal device that is to resend the HARQ information; or the first indication information indicates, by using a status value, a first terminal device that is not to resend the HARQ information.

In at least one embodiment, the communication module is further configured to send second indication information, where the second indication information indicates whether the at least one first terminal device is to combine and send HARQ information that is not successfully sent and HARQ information that is to be sent next time.

In at least one embodiment, the second indication information is unrelated to the identifier of the at least one first terminal device. The second indication information indicates that the HARQ information that is not successfully sent and the HARQ information that is to be sent next time is to be combined and sent, or the second indication information indicates that the HARQ information that is not successfully sent and the HARQ information that is to be sent next time are not to be combined and sent.

In at least one embodiment, the second indication information is related to the identifier of the at least one first terminal device. The second indication information indicates, by using a bitmap, whether the at least one first terminal device is to combine and send the HARQ information that is not successfully sent and the HARQ information that is to be sent next time; the second indication information indicates, by using a status value, a first terminal device that is to combine and send the HARQ information that is not successfully sent and the HARQ information that is to be sent next time; or the second indication information indicates, by using a status value, a first terminal device that is not to combine and send the HARQ information that is not successfully sent and the HARQ information that is to be sent next time.

In at least one embodiment, the second indication information further indicates PSSCH information corresponding to HARQ information that is to be combined and sent. Alternatively, the second indication information further indicates HARQ process information corresponding to HARQ information that is to be combined and sent.

In at least one embodiment, the at least one first terminal device and a second terminal device belong to a same terminal device group.

In at least one embodiment, the communication module includes an interface or a transceiver.

In at least one embodiment, the apparatus is a chip.

In at least one embodiment, the apparatus is a terminal device

According to a thirteenth aspect, an embodiment provides a HARQ feedback apparatus. The apparatus is a terminal device, or is a chip or a chip set in the terminal device. The apparatus includes a processing module and a transceiver module. When the apparatus is the terminal device, the processing module is a processor, and the transceiver module is a transceiver. The apparatus further includes a storage module, and the storage module is a memory. The storage module is configured to store instructions, and the processing module executes the instructions stored in the storage module, to enable the terminal device to perform the corresponding function according to any one of the first aspect to the twelfth aspect. When the apparatus is the chip or the chip set in the terminal device, the processing module is a processor, and the transceiver module is an input/output interface, a pin, a circuit, or the like. The processing module executes instructions stored in a storage module, to enable the terminal device to perform the corresponding function according to any one of the first aspect to the twelfth aspect. The storage module is a storage module (for example, a register or a cache) in the chip or the chip set, or a storage module (for example, a read-only memory or a random access memory) that is in the terminal device and that is located outside the chip or the chip set.

According to a fourteenth aspect, a HARQ feedback apparatus is provided, including a processor, a communication interface, and a memory. The communication interface is configured to transmit information, and/or a message, and/or data between the apparatus and another apparatus. The memory is configured to store computer-executable instructions. When the apparatus runs, the processor executes the computer-executable instructions stored in the memory, to enable the apparatus to perform the HARQ feedback method according to any one of the first aspect or the designs of the first aspect, any one of the second aspect or the designs of the second aspect, any one of the third aspect or the designs of the third aspect, any one of the fourth aspect or the designs of the fourth aspect, any one of the fifth aspect or the designs of the fifth aspect, any one of the sixth aspect or the designs of the sixth aspect, any one of the seventh aspect or the designs of the seventh aspect, any one of the eighth aspect or the designs of the eighth aspect, any one of the ninth aspect or the designs of the ninth aspect, any one of the tenth aspect or the designs of the tenth aspect, any one of the eleventh aspect or the designs of the eleventh aspect, or any one of the twelfth aspect or the designs of the twelfth aspect.

According to a fifteenth aspect, an embodiment provides a computer storage medium. The computer storage medium stores program instructions. When the program instructions are run on a communication device, the communication device is enabled to perform the method according to any one of the first aspect or the designs of the first aspect, any one of the second aspect or the designs of the second aspect, any one of the third aspect or the designs of the third aspect, any one of the fourth aspect or the designs of the fourth aspect, any one of the fifth aspect or the designs of the fifth aspect, any one of the sixth aspect or the designs of the sixth aspect, any one of the seventh aspect or the designs of the seventh aspect, any one of the eighth aspect or the designs of the eighth aspect, any one of the ninth aspect or the designs of the ninth aspect, any one of the tenth aspect or the designs of the tenth aspect, any one of the eleventh aspect or the designs of the eleventh aspect, or any one of the twelfth aspect or the designs of the twelfth aspect of embodiments.

According to a sixteenth aspect, an embodiment provides a computer program product. When the computer program product runs on a communication device, the communication device is enabled to perform the method according to any one of the first aspect or the designs of the first aspect, any one of the second aspect or the designs of the second aspect, any one of the third aspect or the designs of the third aspect, any one of the fourth aspect or the designs of the fourth aspect, any one of the fifth aspect or the designs of the fifth aspect, any one of the sixth aspect or the designs of the sixth aspect, any one of the seventh aspect or the designs of the seventh aspect, any one of the eighth aspect or the designs of the eighth aspect, any one of the ninth aspect or the designs of the ninth aspect, any one of the tenth aspect or the designs of the tenth aspect, any one of the eleventh aspect or the designs of the eleventh aspect, or any one of the twelfth aspect or the designs of the twelfth aspect of embodiments.

According to a seventeenth aspect, an embodiment provides a chip. The chip is coupled to a memory, and performs the method according to any one of the first aspect or the designs of the first aspect, any one of the second aspect or the designs of the second aspect, any one of the third aspect or the designs of the third aspect, any one of the fourth aspect or the designs of the fourth aspect, any one of the fifth aspect or the designs of the fifth aspect, any one of the sixth aspect or the designs of the sixth aspect, any one of the seventh aspect or the designs of the seventh aspect, any one of the eighth aspect or the designs of the eighth aspect, any one of the ninth aspect or the designs of the ninth aspect, any one of the tenth aspect or the designs of the tenth aspect, any one of the eleventh aspect or the designs of the eleventh aspect, or any one of the twelfth aspect or the designs of the twelfth aspect of embodiments.

In addition, for technical effects achieved by the seventh aspect to the twelfth aspect, refer to the descriptions in the first aspect to the sixth aspect. Details are not described herein again.

In embodiments described herein, “coupling” indicates a direct combination or an indirect combination of two components.

### BRIEF DESCRIPTION OF DRAWINGS

FIG. 1 is a schematic diagram of an architecture of a communication system;

FIG. 2 is a schematic diagram of a D2D transmission resource;

FIG. 3 is a schematic diagram of a D2D transmission resource configuration method;

FIG. 4 is a schematic flowchart of a HARQ feedback method;

FIG. 5 is a schematic diagram of a data format;

FIG. 6 is a schematic diagram of another data format;

FIG. 7 is a schematic diagram of a PSFCH;

FIG. 8 is a schematic diagram of another PSFCH;

FIG. 9 is a schematic diagram of transmitting a PSFCH;

FIG. 10 is a schematic flowchart of another HARQ feedback method;

FIG. 11 is a schematic diagram of transmitting a PSFCH;

FIG. 12 is a schematic flowchart of another HARQ feedback method;

FIG. 13 is a schematic diagram of transmitting a PSFCH;

FIG. 14 is a schematic diagram of a structure of a HARQ feedback apparatus; and

FIG. 15 is a schematic diagram of a structure of a terminal device.

### DESCRIPTION OF EMBODIMENTS

A HARQ feedback method provided in this application is applied to a 5G new radio (new radio, NR) unlicensed (unlicensed) system, or is applied to another communication system, for example, an Internet of Things (Internet of Things, IoT) system, a vehicle-to-everything (vehicle-to-everything, V2X) system, a narrowband Internet of Things (narrowband Internet of Things, NB-IoT) system, an LTE system, a fifth generation (5G) communication system, a hybrid LTE and 5G architecture, an NR system, and a new communication system emerging in future communication development. The HARQ feedback method provided in embodiments is used, provided that an entity in the communication system is to send data and another entity is to send HARQ information corresponding to the data.

A terminal is an entity on a user side configured to receive or transmit a signal. The terminal is a device that provides a user with voice and/or data connectivity, for example, a handheld device or a vehicle-mounted device having a wireless connection function. The terminal alternatively is another processing device connected to a wireless modem. The terminal communicates with one or more core networks via a radio access network (radio access network, RAN). The terminal is further referred to as a wireless terminal, a subscriber unit (subscriber unit), a subscriber station (subscriber station), a mobile station (mobile station), a mobile (mobile) console, a remote station (remote station), an access point (access point), a remote terminal (remote terminal), an access terminal (access terminal), a user terminal (user terminal), a user agent (user agent), a user device (user device), user equipment (user equipment, UE), or the like. The terminal device is a mobile terminal, for example, a mobile phone (or referred to as a “cellular” phone) or a computer that has a mobile terminal. For example, the terminal device is a portable, pocket-sized, handheld, computer built-in, or vehicle-mounted mobile apparatus, which exchanges voice and/or data with the radio access network. For example, the terminal device alternatively is a device such as a personal communications service (personal communications service, PCS) phone, a cordless telephone set, a session initiation protocol (session initiation protocol, SIP) phone, a wireless local loop (wireless local loop, WLL) station, or a personal digital assistant (personal digital assistant, PDA). For example, common terminal devices include a mobile phone, a tablet computer, a notebook computer, a palmtop computer, a mobile internet device (mobile internet device, MID), a wearable device such as a smartwatch, a smart band, or a pedometer, and a smart home appliance such as a smart refrigerator or a smart washing machine. However, embodiments are not limited thereto.

A network device is an entity on a network side configured to transmit or receive a signal. For example, the network device is an evolved NodeB (evolved NodeB, eNB, or e-NodeB) in LTE, a new radio controller (new radio controller, NR controller), a gNodeB (gNB) in a 5G system, a centralized network element (centralized unit), a new radio base station, a remote radio module, a micro base station, a relay (relay), a distributed network element (distributed unit), a transmission reception point (transmission reception point, TRP), a transmission point (transmission point, TP), or any other radio access device. However, embodiments are not limited thereto. The network device covers one or more cells.

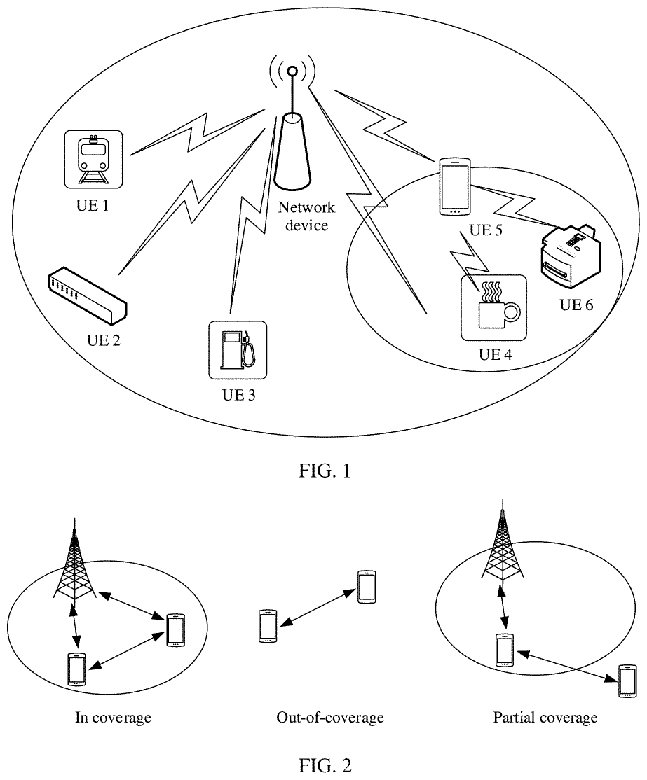

FIG. 1 shows a communication system according to an embodiment. The communication system includes a network device and six terminal devices, for example, UE 1 to UE 6. In the communication system, the UE 1 to the UE 6 sends signals to the network device on an uplink, and the network device receives the uplink signals sent by the UE 1 to the UE 6. In addition, a communication subsystem alternatively includes the UE 4 to the UE 6. The network device sends downlink signals to the UE 1, the UE 2, the UE 3, and the UE 5 on a downlink. The UE 5 sends signals to the UE 4 and the UE 6 on an inter-terminal link (sidelink, SL) based on a D2D technology. FIG. 1 is merely a schematic diagram, and a type of the communication system, a quantity of devices included in the communication system, a type of the device included in the communication system, and the like are not limited in this application.

Network architectures and service scenarios described in embodiments are intended to describe the technical solutions in embodiments more clearly, and do not constitute a limitation on the technical solutions provided in embodiments. A person of ordinary skill in the art learns, with evolution of the network architectures and emergence of new service scenarios, that the technical solutions provided in embodiments are also applicable to similar technical problems.

LTE starts to support device-to-device communication (D2D or Sidelink Communication for short) in a cellular network since 3GPP Release 12. As shown in FIG. 2, three application scenarios defined in a standard are in coverage (in coverage), out-of-coverage (out-of-coverage) and partial coverage (partial coverage).

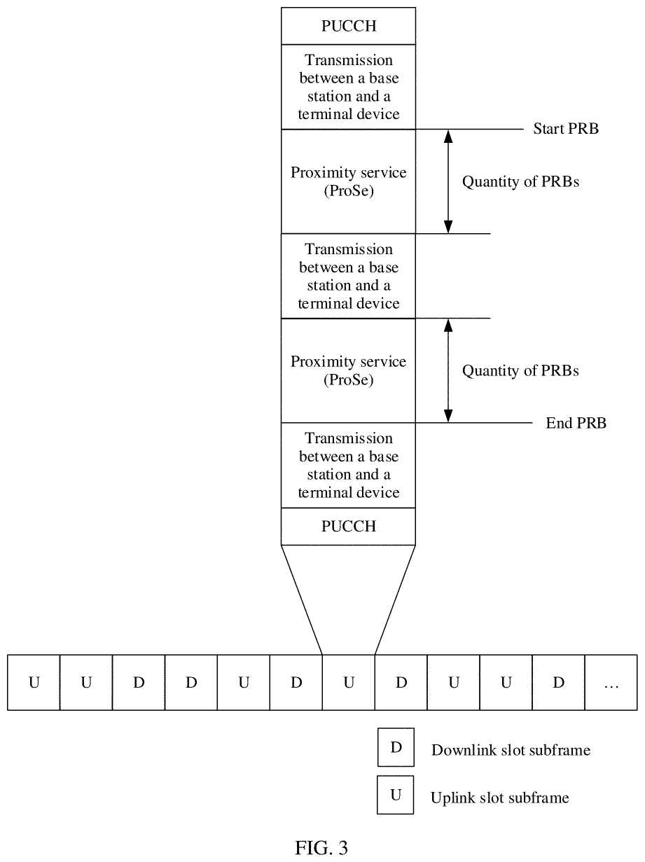

To avoid a conflict between D2D communication and existing universal user (universal user, Uu) communication, the standard specifies a resource pool used for D2D communication, e.g., a base station configures, by using radio resource control (radio resource control, RRC) signaling, some common time-frequency resources used for D2D transmission. As shown in FIG. 3, slots (slots) used for D2D transmission are distributed in an uplink slot subframe. In a subframe used for D2D transmission, frequency resources used for sidelink transmission are divided into two subbands. For one subband, a start physical resource block (physical resource block, PRB) (that is, a PRB-Start) is used to indicate a frequency start point of the subband, and for the other subband, an end PRB (that is, a PRB-End) is used to indicate a frequency end point of the other subband. A frequency width of the subbands is represented by a PRB quantity (PRB-number). A frequency resource that is not used for a sidelink is used for transmission between the base station and a terminal.

Based on frequency bands in which D2D technologies are operated, the D2D technologies is classified into a D2D technology that is operated in a licensed frequency band and a D2D technology that is operated in an unlicensed frequency band.

A communication system deployed in an unlicensed spectrum usually uses/shares an unlicensed resource in a contention manner. Usually, before sending a signal, a station first listens to whether the unlicensed spectrum is idle, for example, determining a busy/idle state of the unlicensed spectrum based on a magnitude of a receive power in the unlicensed spectrum. If the receive power is less than a particular threshold, it is considered that the unlicensed spectrum is in the idle state, and the signal is sent in the unlicensed spectrum. If the receive power is not less than a particular threshold, the signal is not sent. This listen before talk mechanism is referred to as LBT.

In a HARQ mechanism of an NR sidelink system, for a sidelink, a dedicated HARQ feedback channel, namely, a PSFCH is defined. Currently, HARQ feedbacks in unicast and multicast modes are supported. In the unicast mode, point-to-point data transmission is performed between terminal devices, and in the multicast mode, point-to-multipoint data transmission is performed between terminal devices.

For the unicast mode, similar to a conventional HARQ feedback mechanism, a receiving device provides a HARQ feedback based on an actual receiving status of data, that is, if a corresponding transport block (transport block, TB) is correctly decoded, a positive acknowledgment (ACK) is fed back; otherwise, a negative acknowledgment (NACK) is fed back.

For the multicast mode, the receiving device determines, based on a receive-transmit distance or an RSRP, whether to provide a HARQ feedback. In other words, in the multicast mode, not all receiving devices feed back HARQ information. However, for a receiving device that provides a feedback, when a HARQ feedback is provided, there are the following two candidate solutions.

Solution 1: HARQ information is fed back in response to failure to decode a corresponding TB and a NACK is fed back. If the decoding is correct, no information is fed back. From a perspective of a sending device, if no NACK is received, it indicates that receiving of a peer device is correct.

Solution 2: A feedback is provided based on an actual receiving status, that is, if decoding is correct, an ACK is fed back; otherwise, a NACK is fed back.

A HARQ feedback resource corresponding to a PSSCH is configured in a resource pool. In an SL resource pool, a PSFCH resource is periodically configured at an interval of N slots. In other words, one period in the PSFCH resource includes N slots.

For the solution 1 in the multicast mode, the receiving device feeds back the NACK, and does not feed back any information if the receiving is correct. However, for the unlicensed spectrum, the receiving device fails to send the NACK due to an LBT failure. In other words, the receiving device does not feed back NACK information due to the LBT failure.

Embodiments provide a HARQ feedback method and apparatus. The method and the apparatus are based on a same technical concept. Because a problem-resolving principle of the method is similar to that of the apparatus, mutual reference is made to implementations of the apparatus and the method. Repeated parts are not described in detail.

According to the method and the apparatus provided in embodiments, the sending device distinguishes whether information is not fed back because the receiving device correctly receives the information, or NACK information fed back by the receiving device is not sent due to an LBT failure. This avoids inconsistent understandings of HARQ information between a receiving side and a sending side, and improves communication efficiency.

“A plurality of” in this application means two or more.

In addition, terms such as “first” and “second” are used for distinguishing and description, but do not indicate or imply relative importance, or a sequence.

One terminal device receives data (for example, a PSSCH) sent by one or more other terminal devices. A terminal device receiving a PSSCH is referred to as a receiving device in the following, and a terminal device sending a PSSCH is referred to as a sending device, that is, one receiving device receives a PSSCH sent by one or more other sending devices. The sending device and the receiving device are relative. For example, in at least one embodiment, the sending device has a receiving function, and the receiving device has a sending function.

In embodiments of this application, a first terminal device is a receiving device, and a second terminal device is a sending device.

When the receiving device communicates with the sending device, the two terminal devices directly communicates without using relay of a network device. For example, a manner in which the receiving device communicates with the sending device is referred to as D2D transmission, sidelink communication, or the like. The manner of communication is not limited herein.

HARQ information is referred to as a HARQ codebook or the like.

In embodiments of this application, the terminal device has one or more source node identifiers (which are also be referred to as source IDs), for example, source IDs, or has one or more multicast IDs/group IDs, for example, destination IDs, where the multicast ID/group ID is an identifier of a terminal device group to which the terminal device belongs. Optionally, in a terminal device group, the terminal device has a source ID, or a group ID. Further, the terminal device in the terminal device group has an intra-group node identifier, where the intra-group node identifier is an identifier allocated to the terminal device in the terminal device group, and there is a one-to-one correspondence between the intra-group node identifier and the source node identifier of the terminal device. For example, a source ID of a terminal device is 0000, and in a terminal device group whose group ID is 05, a corresponding intra-group node identifier is 01.

The following describes the HARQ feedback provided in embodiments of this application with reference to the accompanying drawings.

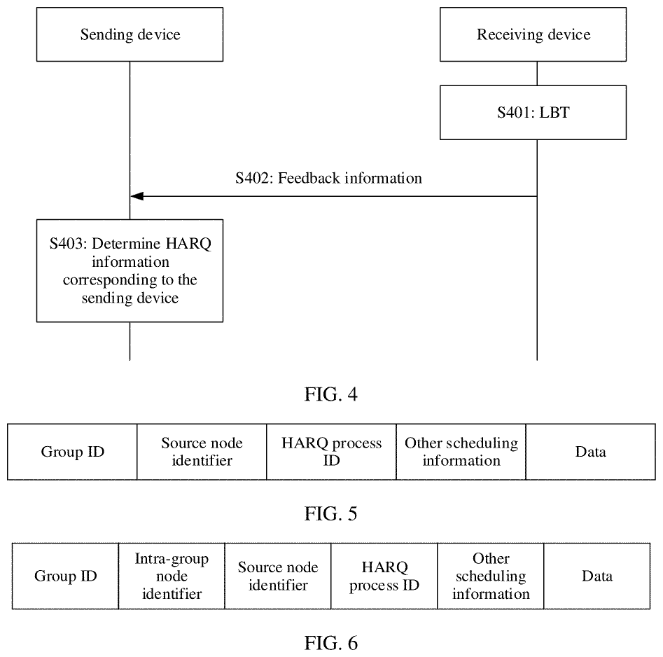

Embodiment 1: FIG. 4 is a flowchart of a HARQ feedback method. The method includes the following steps.

S401: A receiving device performs LBT.

S402: After the LBT succeeds, the receiving device sends feedback information on a channel resource on which the LBT succeeds, where the feedback information includes HARQ information of a plurality of sending devices. Correspondingly, any one of the plurality of sending devices detects, on a channel resource, the feedback information sent by the receiving device.

In an implementation, the channel resource is a feedback channel corresponding to the receiving device. For example, the feedback channel is a PSFCH. The following uses the PSFCH as an example for description.

S403: The sending device determines, based on the feedback information, the HARQ information corresponding to the sending device.

According to step S402, when providing a HARQ feedback, the receiving device provides a HARQ feedback for one or more sending devices on one PSFCH. For a sending device, a HARQ feedback sent by the receiving device for the sending device is obtained from the PSFCH sent by the receiving device.

In this embodiment, the receiving device includes the HARQ information of the plurality of sending devices on one PSFCH. For different sending devices, the LBT is performed for a plurality of times, thereby reducing LBT overheads, and overcoming a problem that HARQ information corresponding to some sending devices cannot be sent in time due to an LBT failure.

One terminal device (the terminal device is a sending device or a receiving device) belongs to one or more terminal device groups. A quantity of devices included in the terminal device group is semi-statically configured.

In a one implementation, the plurality of sending devices and the receiving device belongs to a same terminal device group. For example, a receiving device 1 and sending devices 2 to 4 belong to a terminal device group 1. In this implementation, the plurality of sending devices is all terminal devices in the terminal device group except the receiving device, or the plurality of sending devices is some terminal devices in the terminal device group except the receiving device.

In another implementation, the receiving device belongs to a plurality of terminal device groups, and the plurality of sending devices belongs to different terminal device groups. For example, the receiving device 1 and the sending device 2 belong to the terminal device group 1, the receiving device 1, the sending device 2, and the sending device 3 belong to a terminal device group 2, and the receiving device 1 and the sending device 4 belong to a terminal device group 3.

When sending data, the terminal device includes an identifier of the terminal device in the data.

If one terminal device is to transmit data in a plurality of terminal device groups, an identifier carried in data includes a source ID of the terminal device. The source ID of the terminal device is carried in the data, so that another terminal device learns of a sending source of the data. If one terminal device is to transmit data in one terminal device group, an identifier carried in data includes at least one of the following identifiers: a source ID of the terminal device, a group ID of the terminal device group, or an intra-group node identifier of the terminal device in the terminal device group. The source ID of the terminal device is carried in the data, so that another terminal device learns of a sending source of the data. The group ID is carried in the data, so that the another terminal device identifies a terminal device group to which the data belongs. The intra-group node identifier is carried in the data, so that the another terminal device identifies a terminal device to which the data belongs in the terminal device group. In addition, the data further carries a HARQ process ID, used to distinguish a HARQ process to which the data belongs. During implementation, the data also carries other scheduling information, which is not specifically limited herein.

A payload (payload) of the intra-group node identifier is less than a payload of the source ID. Therefore, compared with the manner in which the source ID of the terminal device is carried in the data, the manner in which the intra-group node identifier is carried in the data reduces system overheads.

For example, as shown in FIG. 5, a data format includes a group ID, a source ID, a HARQ process ID, other scheduling information, and data. As shown in FIG. 6, a data format includes a group ID, an intra-group node identifier, a source ID, a HARQ process ID, other scheduling information, and data.

FIG. 5 and FIG. 6 are examples of embodiments, and examples in FIG. 5 and FIG. 6 are used to logically describe information content that is carried in data sent by the sending device. Information that is carried in the data sent by the sending device and a format, for example, a sending sequence, are not limited.

From a perspective of a receiving device, a HARQ feedback is provided for received information, to help a sending device determine whether data is correctly received. One receiving device receives data sent by a plurality of sending devices. In this case, the receiving device sends HARQ information to the plurality of sending devices. In this embodiment of this application, the receiving device provides a HARQ feedback on one PSFCH for some or all of the plurality of sending devices.

As described above, when providing the HARQ feedback, the receiving device provides a HARQ feedback for at least one sending device on one PSFCH. In an implementation, for a sending device, if a receiving device receives data sent by the sending device, the receiving device feeds back HARQ information based on an actual receiving status. For example, if the data sent by the sending device is received and correctly decoded, an ACK is fed back. If the data sent by the sending device is received and is not correctly decoded, a NACK is fed back. If the data sent by the sending device is not received, default HARQ information such as a NACK is fed back.

For example, a terminal device 1 receives data from terminal devices 2 to 4, and the terminal device 2 receives data sent by the terminal device 1, the terminal device 3, and the terminal device 4. This is similar for other terminal devices. Therefore, when providing a HARQ feedback, the terminal device 1 includes HARQ information for the terminal devices 2 to 4 on one PSFCH. Further, the sending device has a plurality of HARQ processes. When sending the HARQ feedback for the sending device, the receiving device provides a HARQ feedback for the HARQ processes of the sending device. In other words, the HARQ information of the sending device includes feedback information corresponding to the plurality of HARQ processes. In an implementation, for a HARQ process in which data is actually received, the receiving device feeds back HARQ information based on an actual receiving status. For example, if the data is received and correctly decoded, an ACK is fed back, or if the data is received and incorrectly decoded, a NACK is fed back. For a HARQ process in which data is not received, default HARQ information such as a NACK is fed back.

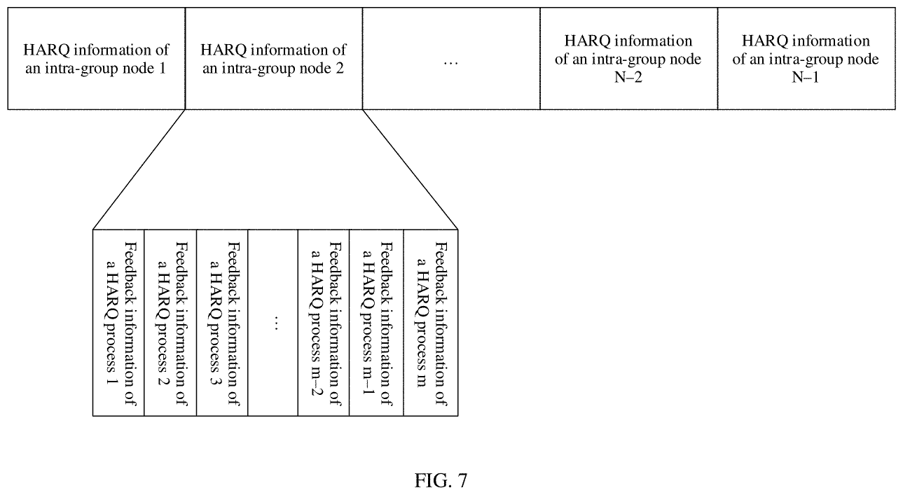

In a implementation, when one receiving device provides a HARQ feedback, a quantity of HARQ information carried in a sent PSFCH is equal to a sum of quantities of HARQ processes of a plurality of sending devices. Optionally, quantities of HARQ processes of the sending devices is the same or is different. When the quantity of HARQ processes corresponding to a sending device is M, the quantity of HARQ information carried in the PSFCH sent by the receiving device is equal to: (a quantity of the plurality of sending devices)*the quantity M of HARQ processes of the sending devices, where M is an integer greater than 0. If one piece of HARQ information occupies one bit, the PSFCH sent by the receiving device includes: (the quantity of the plurality of sending devices) the quantity M of HARQ processes of the sending device bits (bits). It is assumed that M is equal to 16, and the terminal devices 1 to 4 are used as an example. When the terminal device 1 provides a HARQ feedback, the PSFCH includes 3*16=48 bits. For the terminal device 1, feedback information of 16 HARQ processes of the terminal device 2, feedback information of 16 HARQ processes of the terminal device 3, and feedback information of 16 HARQ processes of the terminal device 4 is sequentially fed back on one PSFCH. For example, FIG. 7 shows a possible PSFCH. Feedback information of HARQ processes of sending devices is sequentially fed back based on a sequence of intra-group node identifiers. FIG. 7 is an example one embodiment a PSFCH. The feedback information of the HARQ processes of the sending devices is alternatively fed back based on another sequence, for example, a sequence of source node identifiers, or a sequence of HARQ process IDs. The processes of providing feedback information is limited herein.

In some embodiments, M is a maximum quantity of HARQ processes supported by one terminal device.

In an implementation, the receiving device further sends an identifier of the receiving device to the plurality of sending devices, where both the identifier of the receiving device and the HARQ information is sent on the PSFCH, or the identifier of the receiving device is sent on another control channel, which is not limited herein.

In an example for description, the identifier of the receiving device includes a source node identifier of the terminal device, so that the sending device learns of a sending source of the HARQ information.

In an example for description, when the plurality of sending devices and the receiving device belong to a same terminal device, the identifier of the receiving device includes at least one of the following identifiers: a source ID of the receiving device, a group ID, or an intra-group node identifier. When the group ID is carried, it is convenient for the sending device to identify a terminal device group from which the HARQ information comes. When the intra-group node identifier is carried, it is convenient for the sending device to identify a terminal device and a terminal device group from which the HARQ information comes.

In addition to the HARQ information, when providing a HARQ feedback, the receiving device further carries other feedback information on the PSFCH.

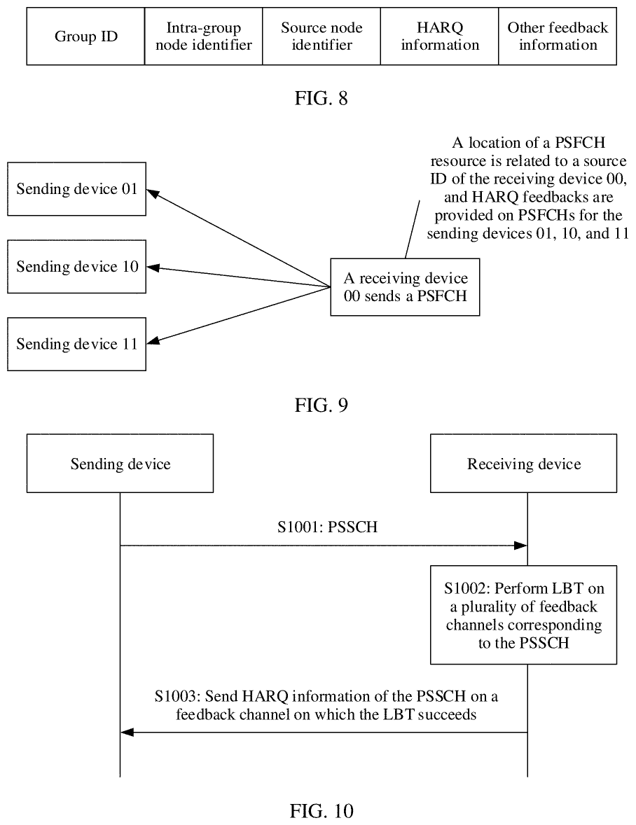

For example, as shown in FIG. 8, when both the identifier of the receiving device and the HARQ information are sent on the PSFCH, the PSFCH includes the group ID of the terminal device group to which the receiving device belongs, the intra-group node identifier allocated to the receiving device in the terminal device group, the source ID of the receiving device, the HARQ information, and other feedback information. It is understood that FIG. 8 is merely an example for description. FIG. 8 logically describes information content that is carried on the PSFCH, and is not a limitation on information carried on the PSFCH, and a format of the PSFCH, for example, a sending sequence.

In this embodiment of this application, the PSFCH is determined based on the identifier of the receiving device, or it is understood that a correspondence exists between the PSFCH and the identifier of the receiving device. For example, a correspondence exists between the PSFCH and the source node identifier of the receiving device. Alternatively, a correspondence exists between the PSFCH and the intra-group node identifier of the receiving device. Alternatively, a correspondence exists between the PSFCH and the source node identifier and the intra-group node identifier that are of the receiving device. The PSFCH is related to another identifier of the receiving device. Examples for description of determining a PSFCH are provided below.

In an example for description, PSFCH=Fun (slot, RB, period, source node identifier of receiving device), and the formula is understood as that a PSFCH of a receiving device is determined by one or more of four factors: a source node identifier of the receiving device, a slot index, an RB index, and a period.

In another example for description, PSFCH resource=Fun (slot, RB, intra-group node identifier of receiving device), and the formula is understood as that a PSFCH of a receiving device is determined by one or more of three factors: an intra-group node identifier of the receiving device, a slot index, and an RB index.

In another example for description, PSFCH resource=Fun (slot, RB, intra-group node identifier of receiving device, source node identifier of receiving device), and the formula is understood as that a PSFCH of a receiving device is determined by one or more of four factors: a source node identifier of the receiving device, an intra-group node identifier of the receiving device, a slot index, and an RB index.

The foregoing several examples do not constitute a limitation on embodiments of this application. There is another correspondence between the PSFCH and the receiving device, which is not listed one by one herein.

If the sending device sends data to the receiving device, a resource location of the PSFCH sent by the receiving device is determined based on the correspondence between the PSFCH and the receiving device, and corresponding HARQ information is received. Therefore, whether the sent data is correctly received by the receiving device is learned.

In some embodiments, before detecting, on the PSFCH, the PSFCH sent by the receiving device, the sending device further determines the PSFCH corresponding to the receiving device.

For example, in an implementation in which a correspondence exists between the PSFCH and the source node identifier of the receiving device, the sending device determines, based on the source node identifier of the receiving device, the PSFCH corresponding to the receiving device, to receive, on the PSFCH, the PSFCH sent by the receiving device. For example, the sending device determines the PSFCH corresponding to the receiving device according to PSFCH=Fun (slot, RB, period, source node identifier of receiving device).

In an implementation in which a correspondence exists between the PSFCH and the intra-group node identifier of the receiving device, the sending device determines, based on the intra-group node identifier of the receiving device, the PSFCH corresponding to the receiving device, to receive, on the PSFCH, the PSFCH sent by the receiving device. For example, the sending device determines the PSFCH corresponding to the receiving device according to PSFCH=Fun (slot, RB, period, intra-group node identifier of receiving device).

In an implementation in which a correspondence exists between the PSFCH and the identifier combination, the sending device determines, based on the group ID of the receiving device and the intra-group node identifier of the receiving device, the PSFCH corresponding to the receiving device, to receive, on the PSFCH, the PSFCH sent by the receiving device. For example, the sending device determines the PSFCH corresponding to the receiving device according to PSFCH=Fun (slot, RB, period, source node identifier of receiving device, intra-group node identifier of receiving device).

In an implementation in which another correspondence exists between the PSFCH and the receiving device, the sending device determines, based on the correspondence, the PSFCH corresponding to the receiving device, which is not listed one by one herein.

In an example of description, assuming that a correspondence exists between the PSFCH and the source node identifier of the receiving device, a receiving device 00 sends HARQ information to sending devices 01, 10, and 11. The sending devices 01, 10, and 11 learns of a resource location of a PSFCH of the receiving device 00 based on a source node identifier of the receiving device 00, to detect corresponding HARQ information at a corresponding location, and further determine whether data sent to the receiving device 00 is correctly received, as shown in FIG. 9.

A device that performs transmission in an unlicensed spectrum performs LBT before performing transmission. Due to randomness of channel occupation, it cannot be ensured that the LBT always succeeds, that is, some transmission fails due to an LBT failure. Before providing a HARQ feedback on the PSFCH, the receiving device also performs LBT. In this case, the HARQ information is not sent in time due to an LBT failure. According to the solutions in embodiments of this application, HARQ information of one or more sending devices is carried on one PSFCH. Even if the sending device cannot receive the HARQ information on a PSFCH due to an LBT failure, the HARQ information is received again on another PSFCH. This minimizes impact of the LBT.

Embodiment 2: FIG. 10 is a flowchart of another HARQ feedback method. The method includes the following steps.

S1001: A sending device sends a PSSCH to a receiving device. Correspondingly, the receiving device receives the PSSCH sent by the sending device.

S1002: The receiving device performs LBT on a plurality of feedback channels corresponding to the PSSCH.

A PSSCH that is sent by the sending device corresponds to one or more receiving devices. In some scenarios, a scenario in which the PSSCH sent by the sending device corresponds to one receiving device is referred to as a unicast scenario. In some other scenarios, a scenario in which the PSSCH sent by the sending device corresponds to a plurality of receiving devices is referred to as a multicast scenario or a broadcast scenario. For any one of the one or more receiving devices, the PSSCH corresponds to a plurality of PSFCHs of the receiving device.

In an implementation, time domain information and/or frequency domain information of the plurality of PSFCHs corresponding to the PSSCH is/are different.

S1003: The receiving device sends HARQ information of the PSSCH to the sending device on one or more feedback channels on which the LBT succeeds. Correspondingly, the sending device detects, on a plurality of feedback channel resources corresponding to the PSSCH, the HARQ information sent by the receiving device.

For a PSSCH in this embodiment of this application, a receiving device that receives the PSSCH has a plurality of PSFCHs that carry HARQ information of the PSSCH. In this implementation, even if the receiving device fails to perform LBT on a PSFCH, the HARQ information of the PSSCH is transmitted through another PSFCH corresponding to the PSSCH.

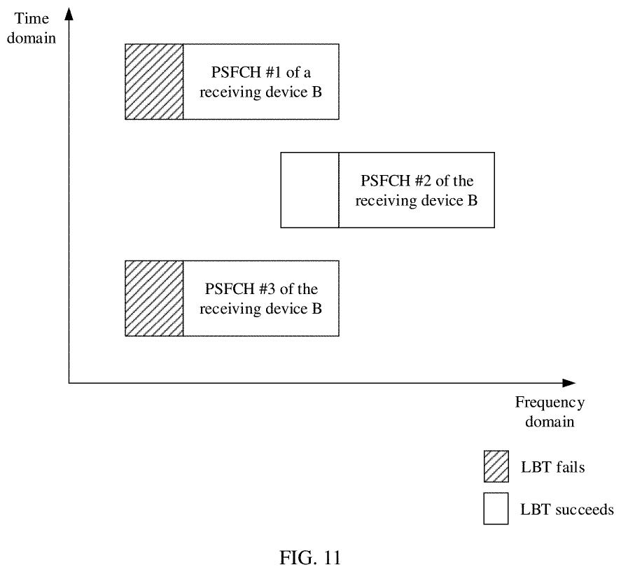

For example, a terminal device A and a terminal device B are used as an example. When the terminal device A is used as a sending device to transmit data, a correspondence exists between a sent PSSCH and a PSFCH of the receiving device B. In addition, for the PSSCH, the receiving device B has three PSFCHs, namely, a PSFCH #1, a PSFCH #2, and a PSFCH #3, corresponding to the PSSCH, and HARQ information is carried on the PSFCH for transmission. LBT that is performed before transmission is performed in an unlicensed spectrum, that is, the receiving device B performs LBT before transmitting the HARQ information on the PSFCH #1, the PSFCH #2, and the PSFCH #3. Therefore, the receiving device B performs transmission on a PSFCH on which the LBT succeeds. For example, before the receiving device B transmits the HARQ information on the PSFCH #1 and the PSFCH #3, the LBT fails, and therefore, a HARQ feedback cannot be provided on the PSFCH #1 and the PSFCH #3, but before the receiving device B transmits the HARQ information on the PSFCH #2, the LBT succeeds, and therefore, the corresponding HARQ information is able to be carried on the PSFCH #2 for transmission. This is shown in FIG. 11. With a multi-resource feedback mechanism, a problem that HARQ feedback transmission cannot be performed due to an LBT failure is avoided.

In this embodiment of this application, the PSFCH is determined based on an identifier of the receiving device, or it is understood that a correspondence exists between the PSFCH and the identifier of the receiving device. For the correspondence between the PSFCH and the identifier of the receiving device, refer to related descriptions in Embodiment 1. Details are not described herein again.

If the sending device sends the PSSCH to the receiving device, a resource location of a PSFCH sent by the receiving device is determined based on a correspondence between the PSFCH and the receiving device, and corresponding HARQ information is received. Therefore, whether the sent PSSCH is correctly received by the receiving device is learned.

In some embodiments, before detecting, on the PSFCH, the PSFCH sent by the receiving device, the sending device further determines the PSFCH corresponding to the receiving device. For a process in which the sending device determines the PSFCH corresponding to the receiving device, refer to related descriptions in Embodiment 1. Details are not described herein again.

In Embodiment 2 of this application, because the PSSCH corresponds to the plurality of feedback channels, the receiving device sends the same HARQ information for a plurality of times. For example, before the receiving device B transmits the HARQ information on the PSFCH #1, the LBT fails, and therefore, a HARQ feedback is not able to be provided on the PSFCH #1, but before the receiving device B transmits the HARQ information on the PSFCH #2 and the PSFCH #3, the LBT succeeds, and therefore, the corresponding HARQ information is able to be carried on the PSFCH #2 and the PSFCH #3 for transmission.

To avoid confusion between a receiving side and a sending side, new indication information is added to SCI, to notify the receiving side and the sending side whether a feedback at this time is a new feedback (new feedback) or a re-feedback, that is, whether currently transmitted HARQ information is newly fed back HARQ information or retransmitted HARQ information. The indication information is sent by the sending device, or is sent by the receiving device. For example, the indication information is referred to as a new feedback indicator.

In addition, indication information indicating a size of the HARQ information is further added to the SCI. Similarly, the indication information is sent by the sending device, or is sent by the receiving device. For example, the indication information indicating the size of the HARQ information is referred to as a HARQ codebook size indicator or a sidelink assignment indicator.

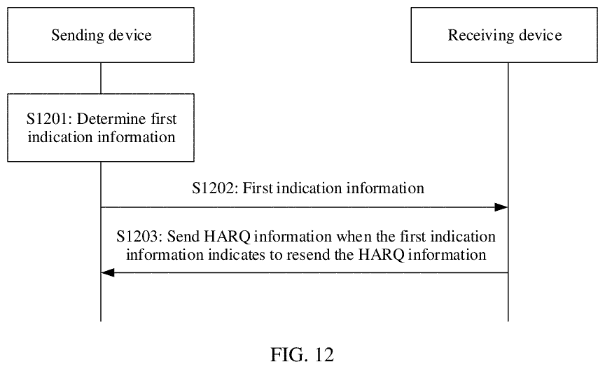

Embodiment 3: FIG. 12 is a flowchart of another HARQ feedback method. The method includes the following steps.

S1201: A sending device determines first indication information, where the first indication information indicates whether at least one receiving device is to resend HARQ information.

The at least one receiving device and the sending device belongs to a same terminal device group.

In an example for description, the first indication information indicates to resend the HARQ information, or that the HARQ information is not to be resent. In this manner, the first indication information is unrelated to an identifier of the at least one receiving device. Alternatively, it receiving devices are not distinguished for the first indication information.

For example, the first indication information gives an indication by using different values of a bit. If a value of the bit is 1, it indicates that the HARQ information is to be resent. If a value of the bit is 0, the HARQ information is not to be resent. For another example, inversion of a bit is used for indication. If the bit is inverted, it indicates that the HARQ information is to be resent. If the bit is not inverted, the HARQ information is not to be resent.

After the sending device sends the first indication information indicating to resend the HARQ information, the at least one receiving device resends the HARQ information. After the sending device sends the first indication information indicating that the HARQ information is not to be resent, the at least one receiving device does not resend the HARQ information.

In another example for description, the first indication information indicates, by using a bitmap, whether the at least one receiving device is to resend the HARQ information, and one bit corresponds to one receiving device. In an implementation, when a value of the bit is 0, it indicates that the HARQ information is not to be resent. When a value of the bit is 1, it indicates that the HARQ information is to be resent. In another implementation, when a value of the bit is 1, it indicates that the HARQ information is not to be resent. When a value of the bit is 0, it indicates that the HARQ information is to be resent.

Optionally, a length of the bitmap is equal to a quantity of the at least one receiving device.

An example in which the value of the bit is 0 indicates that the HARQ information is not to be resent, or the value of the bit is 1 indicates that the HARQ information is to be resent is used for description. For receiving devices 1 to 7, the first indication information is 1110110, indicating that the receiving devices 1 to 3, 5, and 6 are to resend the HARQ information, and the receiving device 4 and the receiving device 7 are not to resend the HARQ information.

Alternatively, the first indication information indicates, by using a status value, a receiving device that is to resend the HARQ information. Table 1 describes an example of a manner in which the first indication information indicates, by using the status value, whether the receiving devices 1 to 4 are to resend the HARQ information.

TABLE 1

| First indication | |
|---|---|
| information | Receiving device that are to resend HARQ information |
| 0000 | None/reserved (reserved) |
| 0001 | Receiving device 1 |
| 0010 | Receiving device 2 |
| 0011 | Receiving device 3 |
| 0100 | Receiving device 4 |
| 0101 | Receiving device 1 and receiving device 2 |
| 0110 | Receiving device 1 and receiving device 3 |
| 0111 | Receiving device 1 and receiving device 4 |
| 1000 | Receiving device 2 and receiving device 3 |
| 1001 | Receiving device 2 and receiving device 4 |
| 1010 | Receiving device 3 and receiving device 4 |
| 1011 | Receiving device 1, receiving device 2, |
| | and receiving device 3 |
| 1100 | Receiving device 1, receiving device 2, |
| | and receiving device 4 |
| 1101 | Receiving device 1, receiving device 3, |
| | and receiving device 4 |
| 1110 | Receiving device 2, receiving device 3, |
| | and receiving device 4 |
| 1111 | Receiving device 1, receiving device 2, |
| | receiving device 3, and receiving device 4 |

Alternatively, the first indication information indicates, by using a status value, a receiving device that is not to resend the HARQ information. A manner in which the first indication information indicates, by using the status value, the receiving device that is not to resend the HARQ information is similar to the manner in which the first indication information indicates, by using the status value, the receiving device that is to resend the HARQ information.

In the three manners in the foregoing another example for description, the first indication information is related to the identifier of the at least one receiving device.

The device identifier is identification information that enables devices to be distinguished. For example, the device identifier is an international mobile equipment identity IMEI, intra-group identification information for distinguishing identification information of different devices in a group, or other identification information for distinguishing different devices. This is not limited in the embodiments described herein.

S1202: The sending device sends the first indication information. Correspondingly, the at least one receiving device receives the first indication information.

S1203: The receiving device resends the HARQ information to the sending device when the first indication information indicates the receiving device to resend the HARQ information.

One receiving device receives data sent by one or more sending devices. Similarly, one sending device receives HARQ information sent by one or more receiving devices. If the data sent by the sending device is not correctly received by the receiving device, retransmission is to be performed. Therefore, the HARQ information sent by the receiving device helps the sending device determine whether to perform retransmission. In an unlicensed spectrum, the receiving device performs LBT before sending the HARQ information. The LBT is uncertain, that is, the receiving device fails to send the HARQ information due to an LBT failure. A PSFCH location corresponding to the receiving device is related to the identifier of the receiving device, and the PSFCH is used to send the HARQ information. After sending a PSSCH, the sending device detects corresponding HARQ information on a PSFCH corresponding to the receiving device, to determine whether the sent PSSCH is correctly received by the receiving device. It is understood that when the receiving device does not send the HARQ information on the corresponding PSFCH due to an LBT failure, the sending device cannot detect the HARQ information on the corresponding PSFCH. In this case, the sending device indicates the receiving device to resend the HARQ information. Therefore, a problem that HARQ information corresponding to some sending devices cannot be sent in time due to an LBT failure is overcome.

Because the sending device corresponds to one or more potential receiving devices, the first indication information sent by the sending device indicates whether a plurality of receiving devices are to resend the HARQ information. Thus, system overheads are reduced.

In a implementation, PSFCHs corresponding to different receiving devices is at a same time-frequency resource location or different time-frequency resource locations. When time-frequency resources of the PSFCHs corresponding to the different receiving devices are different, a correspondence between the receiving device and the PSFCH is similar to the correspondence between the receiving device and the PSFCH in Embodiment 1 and Embodiment 2, and repeated parts are not described in detail again. When time-frequency resources of the PSFCHs corresponding to the different receiving devices are the same, HARQ information of the different receiving devices is distinguished in another manner, for example, a code division manner.

An example in which the sending device and at least one device belong to a same terminal device group is used for description. It is assumed that a maximum quantity of terminal devices supported in a terminal device group whose group identifier is 05 is 4, and intra-group node identifiers corresponding to the four terminal devices are respectively 00, 01, 10, and 11. The four terminal devices have a corresponding source node identifier. For example, a source node identifier corresponding to the terminal device 00 is 0001. Data sent by the terminal device 00 is received by the terminal device 01, the terminal device 10, and the terminal device 11. Therefore, the terminal device 01, the terminal device 10, and the terminal device 11 all are to provide HARQ feedbacks, and the terminal device 00 detects HARQ information on PSFCHs corresponding to the terminal device 01, the terminal device 10, and the terminal device 11. It is understood that, in an unlicensed spectrum, the terminal device 01, the terminal device 10, and the terminal device 11 all are to perform LBT before sending the HARQ information, that is, the terminal device 01, the terminal device 10, and the terminal device 11 fail to send the HARQ information on the PSFCHs corresponding to the terminal devices due to an LBT failure. It is assumed that the terminal device 10 fails to send the HARQ information due to the LBT failure. In this case, the terminal device 00 gives an indication by using 3-bit bitmap information. The first bit corresponds to the terminal device 01, the second bit corresponds to the terminal device 10, and the third bit corresponds to the terminal device 11. Therefore, “010” indicates the terminal device 10 to resend the HARQ information. A bit “1” in the bitmap information indicates that a corresponding receiving device is to resend the HARQ information.

In some embodiments, before step S1203 is performed, the sending device further sends second indication information, where the second indication information indicates whether the at least one receiving device is to combine and send HARQ information that is not successfully sent and HARQ information that is to be sent next time. Correspondingly, the receiving device receives the second indication information sent by the sending device.

The HARQ information that is to be sent next time is currently to-be-sent HARQ information or HARQ information that is to be sent in the future.

Optionally, the second indication information and the first indication information give indications separately, or give indications simultaneously. For simultaneous indication, in a possible implementation, when indicating that the at least one receiving device is to resend the HARQ information, the first indication information simultaneously indicates whether the HARQ information that is not successfully sent and the HARQ information that is to be sent next time are to be combined and sent.

An indication manner of the second indication information is similar to an indication manner of the first indication information, where indication content is different, and the indication manners are the same. For the indication manner of the second indication information, refer to the indication manner of the first indication information. Details are not described herein again.

One PSSCH is transmitted in one HARQ process. A correspondence exists between the HARQ information and the PSSCH sent by the sending device, and a correspondence also exists between the HARQ information and a HARQ process for transmitting the PSSCH.

For example, the second indication information gives an indication based on the PSSCH. In this implementation, the second indication information alternatively indicates PSSCH information corresponding to HARQ information that is to be combined and sent. The second indication information indicates PSSCHs with corresponding HARQ information that is to be combined.

The second indication information alternatively indicates based on a HARQ process. In this implementation, the second indication information alternatively indicates HARQ process information corresponding to HARQ information that is to be combined and sent. The second indication information indicates HARQ processes with corresponding HARQ information that is to be combined.

The second indication information alternatively indicates one or more of the following quantity information: a quantity of PSSCHs with HARQ information that is to be combined and sent, a quantity of PSSCH sets with HARQ information that is to be combined and sent, a quantity of HARQ processes in which HARQ information are to be combined and sent, and the like.

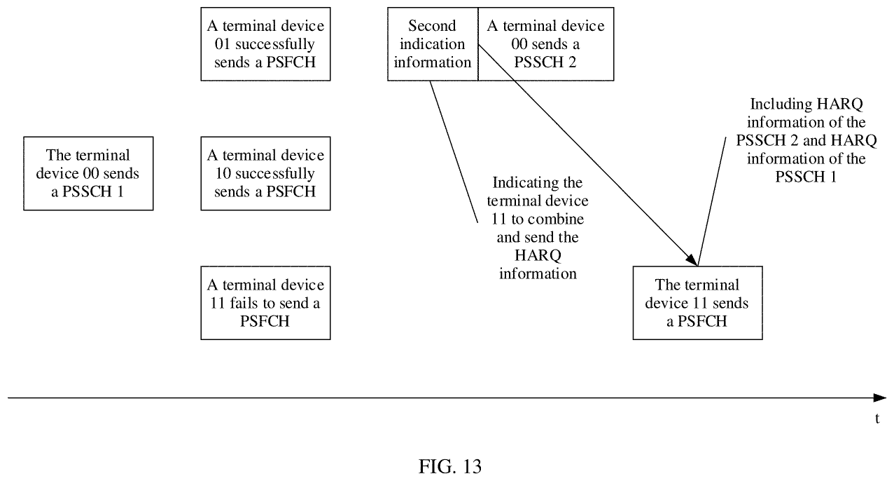

For example, as shown in FIG. 13, after the terminal device 00 sends a PSSCH 1, the terminal device 01, the terminal device 10, and the terminal device 11 sends HARQ information of the PSSCH 1 on their respective first PSFCHs. It is assumed that the terminal device 11 fails to send the HARQ information of the PSSCH 1 due to an LBT failure. In this case, before the terminal device 00 sends a PSSCH 2, the terminal device 11 is indicated by the second indication information to combine the HARQ information of the PSSCH 1 and HARQ information of a subsequent PSSCH (for example, the PSSCH 2 or a future PSSCH 3) for sending. For example, the second indication information indicates, by using a bitmap=001, that the terminal device 11 is to perform HARQ information combination. Optionally, the second indication information indicates whether HARQ information of the terminal device 11 is to be combined with future HARQ information. For example, an indication is given by a bit of the second indication information. In response to the bit being equal to 1, the HARQ information of the terminal device 11 is combined with HARQ information of a future PSSCH (for example, the PSSCH 3) and not HARQ information of the current PSSCH 2. In FIG. 13, the second PSFCH of the terminal device 11 corresponds to a HARQ feedback of the current PSSCH 2, and the third PSFCH corresponds to a HARQ feedback of the future PSSCH (for example, the PSSCH 3). In response to the bit being equal to 0, HARQ information combination is performed on the third PSFCH.

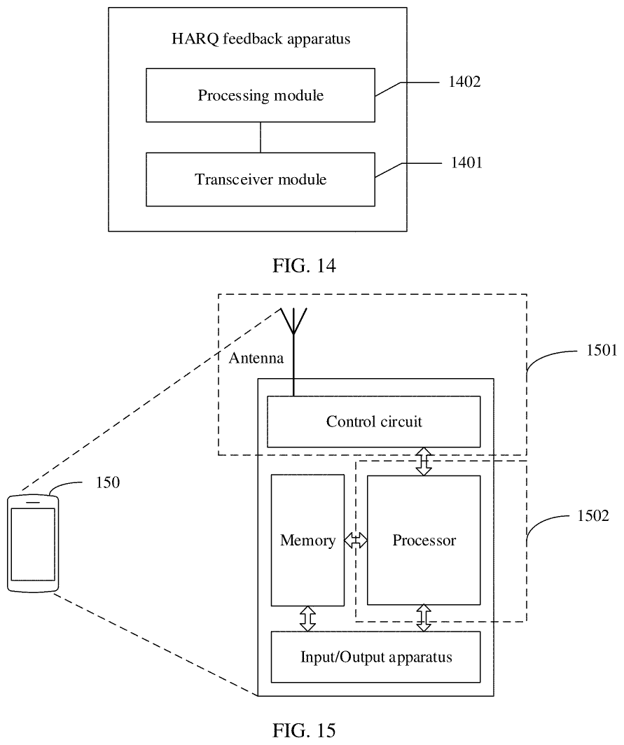

Based on a same concept as the method embodiments, an embodiment of this application provides a HARQ feedback apparatus. A structure of the HARQ feedback apparatus is shown in FIG. 14, and includes a transceiver module 1401 and a processing module 1402.

In an implementation, the HARQ feedback apparatus is configured to implement the methods performed by the receiving device in the embodiments in FIG. 4 to FIG. 9. The apparatus is the receiving device, or is a chip or a chip set in the receiving device, or a part of a chip configured to perform a related method function. The processing module 1402 is configured to perform LBT. The transceiver module 1401 is configured to: after the LBT succeeds, send HARQ information of a plurality of second terminal devices on a channel resource on which the LBT succeeds.

For example, any second terminal device has a plurality of HARQ processes, and HARQ information of the second terminal device includes feedback information corresponding to the plurality of HARQ processes.

In a implementation, the transceiver module 1401 is further configured to send an identifier of a first terminal device to the plurality of second terminal devices.

In a implementation, when sending the HARQ information of the plurality of second terminal devices on the channel resource on which the LBT succeeds, the transceiver module 1401 is configured to send the HARQ information of the plurality of second terminal devices on a feedback channel on which the LBT succeeds. A correspondence exists between the feedback channel and the first terminal device.

For example, the feedback channel is determined based on the identifier of the first terminal device.

In at least one embodiment, the first terminal device and the plurality of second terminal devices are located in a same terminal device group, and the identifier of the first terminal device includes one or more of the following identifiers: an identifier of the terminal device group, an identifier of the first terminal device in the terminal device group, or a source ID of the first terminal device.

Alternatively, the identifier of the first terminal device includes a source ID of the first terminal device.

The transceiver module 1401 is further configured to: after sending the HARQ information of the plurality of second terminal devices on the channel resource on which the LBT succeeds, receive indication information sent by the second terminal device, where the indication information indicates whether at least one terminal device including the first terminal device is to resend the HARQ information; and resend the HARQ information to the second terminal device when the indication information indicates the first terminal device to resend the HARQ information.

In another embodiment, the HARQ feedback apparatus is configured to implement the methods performed by the sending device in the embodiments in FIG. 4 to FIG. 9. The apparatus is the sending device, or is a chip or a chip set in the sending device, or a part of a chip configured to perform a related method function. The transceiver module 1401 is configured to detect, on a channel resource, feedback information sent by a first terminal device, where the feedback information includes HARQ information of a plurality of terminal devices including a second terminal device. The processing module 1402 is configured to determine, based on the feedback information, HARQ information corresponding to the second terminal device.

For example, the second terminal device has a plurality of HARQ processes, and the HARQ information of the second terminal device includes feedback information corresponding to the plurality of HARQ processes.

The transceiver module 1401 is further configured to receive an identifier of the first terminal device.

For example, the channel resource is a feedback channel corresponding to the first terminal device.

For example, the feedback channel is determined based on the identifier of the first terminal device.

In at least one embodiment, the first terminal device and the plurality of second terminal devices are located in a same terminal device group, and the identifier of the first terminal device includes one or more of the following identifiers: an identifier of the terminal device group, an identifier of the first terminal device in the terminal device group, or a source ID of the first terminal device.

Alternatively, the identifier of the first terminal device includes a source ID of the first terminal device.

The processing module 1402 is further configured to: after the transceiver module 1401 detects, on the channel resource, the feedback information sent by the first terminal device, determine indication information, where the indication information indicates whether the at least one first terminal device is to resend the HARQ information. The transceiver module 1401 is further configured to send the indication information.

In another implementation, the HARQ feedback apparatus is configured to implement the methods performed by the receiving device in the embodiments in FIG. 10 to FIG. 11. The apparatus is the receiving device, or is a chip or a chip set in the receiving device, or a part of a chip configured to perform a related method function. The transceiver module 1401 is configured to receive a PSSCH sent by a second terminal device. The processing module 1402 is configured to perform LBT on a plurality of feedback channels corresponding to the PSSCH. The transceiver module 1401 is further configured to send HARQ information of the PSSCH to the second terminal device on one or more feedback channels on which the LBT succeeds.

The transceiver module 1401 is further configured to: send SCI to the second terminal device, or receive SCI sent by the second terminal device. The SCI carries indication information indicating that the HARQ information is newly fed back HARQ information, or the SCI carries indication information indicating that the HARQ information is retransmitted HARQ information.

For example, the SCI further carries indication information indicating a size of the HARQ information.

In at least one embodiment, a correspondence exists between the feedback channel and a first terminal device.

Further, the feedback channel is determined based on an identifier of the first terminal device.

For example, the first terminal device and a plurality of second terminal devices are located in a same terminal device group, and the identifier of the first terminal device includes one or more of the following identifiers: an identifier of the terminal device group, an identifier of the first terminal device in the terminal device group, or a source ID of the first terminal device.

Alternatively, the identifier of the first terminal device includes a source ID of the first terminal device.

The transceiver module 1401 is further configured to: after sending the HARQ information of the PSSCH to the second terminal device on the one or more feedback channels on which the LBT succeeds, receive first indication information sent by the second terminal device, where the first indication information indicates whether at least one terminal device including the first terminal device is to resend the HARQ information; and resend the HARQ information to the second terminal device when the first indication information indicates the first terminal device to resend the HARQ information.

In another implementation, the HARQ feedback apparatus is configured to implement the methods performed by the sending device in the embodiments in FIG. 10 to FIG. 11. The apparatus is the sending device, or is a chip or a chip set in the sending device, or a part of a chip configured to perform a related method function. The transceiver module 1401 is configured to: send a PSSCH to a first terminal device; and detect, on a plurality of feedback channels corresponding to the PSSCH, HARQ information sent by the first terminal device.

The transceiver module 1401 is further configured to: receive SCI sent by the first terminal device, or send SCI to the first terminal device. The SCI carries indication information indicating that the HARQ information is newly fed back HARQ information, or the SCI carries indication information indicating that the HARQ information is retransmitted HARQ information.

For example, the SCI further carries indication information indicating a size of the HARQ information.

Optionally, a correspondence exists between the feedback channel and the first terminal device.

The apparatus further includes the processing module 1402, configured to determine the feedback channel based on an identifier of the first terminal device.

For example, the first terminal device and a plurality of second terminal devices are located in a same terminal device group, and the identifier of the first terminal device includes one or more of the following identifiers: an identifier of the terminal device group, an identifier of the first terminal device in the terminal device group, or a source ID of the first terminal device.

Alternatively, the identifier of the first terminal device includes a source ID of the first terminal device.

The processing module 1402 is configured to: after the HARQ information sent by the first terminal device is detected on the plurality of feedback channels corresponding to the PSSCH, determine first indication information, where the first indication information indicates whether at least one first terminal device is to resend the HARQ information; and the transceiver module 1401 is further configured to send the first indication information.

In another implementation, the HARQ feedback apparatus is configured to implement the methods performed by the receiving device in the embodiments in FIG. 12 to FIG. 13. The apparatus is the receiving device, or is a chip or a chip set in the receiving device, or a part of a chip configured to perform a related method function. The transceiver module 1401 is configured to: receive first indication information sent by a second terminal device, where the first indication information indicates whether at least one terminal device including a first terminal device is to resend HARQ information; and resend the HARQ information to the second terminal device when the first indication information indicates the first terminal device to resend the HARQ information.

In an example for description, the first indication information indicates to resend the HARQ information, or the first indication information indicates that the HARQ information is not to be resent.

In another example for description, the first indication information indicates, by using a bitmap, whether the at least one terminal device is to resend the HARQ information; the first indication information indicates, by using a status value, a terminal device that is to resend the HARQ information; or the first indication information indicates, by using a status value, a terminal device that is not to resend the HARQ information.

The transceiver module 1401 is further configured to receive second indication information sent by the second terminal device, where the second indication information indicates whether the at least one terminal device is to combine and send HARQ information that is not successfully sent and HARQ information that is to be sent next time.

The second indication information is unrelated to an identifier of the at least one terminal device. The second indication information indicates that the HARQ information that is not successfully sent and the HARQ information that is to be sent next time are to be combined and sent, or the second indication information indicates that the HARQ information that is not successfully sent and the HARQ information that is to be sent next time are not to be combined and sent.

Alternatively, the second indication information is related to an identifier of the at least one terminal device. The second indication information indicates, by using a bitmap, whether the at least one terminal device is to combine and send the HARQ information that is not successfully sent and the HARQ information that is to be sent next time; the second indication information indicates, by using a status value, a terminal device that is to combine and send the HARQ information that is not successfully sent and the HARQ information that is to be sent next time; or the second indication information indicates, by using a status value, a terminal device that is not to combine and send the HARQ information that is not successfully sent and the HARQ information that is to be sent next time.

Optionally, the second indication information further indicates PSSCH information corresponding to HARQ information that is to be combined and sent. Alternatively, the second indication information further indicates HARQ process information corresponding to HARQ information that is to be combined and sent.

When resending the HARQ information to the second terminal device, the transceiver module 1401 is configured to combine and send the HARQ information that is not successfully sent and the HARQ information that is to be sent next time.

For example, the at least one terminal device and the second terminal device belong to a same terminal device group.

In another implementation, the HARQ feedback apparatus is configured to implement the methods performed by the sending device in the embodiments in FIG. 12 to FIG. 13. The apparatus is the sending device, or is a chip or a chip set in the sending device, or a part of a chip configured to perform a related method function. The processing module 1402 is configured to determine first indication information, where the first indication information indicates whether at least one first terminal device is to resend HARQ information. The transceiver module 1401 is configured to send the first indication information.

In an example for description, the first indication information is unrelated to an identifier of the at least one first terminal device. The first indication information indicates to resend the HARQ information, or the first indication information indicates that the HARQ information is not to be resent.

In another example for description, the first indication information is related to an identifier of the at least one first terminal device. The first indication information indicates, by using a bitmap, whether the at least one first terminal device is to resend the HARQ information; the first indication information indicates, by using a status value, a first terminal device that is to resend the HARQ information; or the first indication information indicates, by using a status value, a first terminal device that is not to resend the HARQ information.

The transceiver module 1401 is further configured to send second indication information, where the second indication information indicates whether the at least one first terminal device is to combine and send HARQ information that is not successfully sent and HARQ information that is to be sent next time.

For example, the second indication information is unrelated to the identifier of the at least one first terminal device. The second indication information indicates that the HARQ information that is not successfully sent and the HARQ information that is to be sent next time are to be combined and sent, or the second indication information indicates that the HARQ information that is not successfully sent and the HARQ information that is to be sent next time are not to be combined and sent.

For example, the second indication information is related to the identifier of the at least one first terminal device. The second indication information indicates, by using a bitmap, whether the at least one first terminal device is to combine and send the HARQ information that is not successfully sent and the HARQ information that is to be sent next time; the second indication information indicates, by using a status value, a first terminal device that is to combine and send the HARQ information that is not successfully sent and the HARQ information that is to be sent next time; or the second indication information indicates, by using a status value, a first terminal device that is not to combine and send the HARQ information that is not successfully sent and the HARQ information that is to be sent next time.

Optionally, the second indication information further indicates PSSCH information corresponding to HARQ information that is to be combined and sent. Alternatively, the second indication information further indicates HARQ process information corresponding to HARQ information that is to be combined and sent.

For example, the at least one first terminal device and a second terminal device belong to a same terminal device group.

Division into the modules in embodiments is merely a division into logical functions, or other division during actual implementation. In addition, functional modules in embodiments is integrated into one processor, or modules exist alone physically, or two or more modules are integrated into one module. The integrated module is implemented in a form of hardware, or is implemented in a form of a software functional module. For functions or implementations of the modules in embodiments, further refer to related descriptions in the method embodiments.

FIG. 15 is a schematic diagram of a structure of a terminal device according to an embodiment. The terminal device is used in the system shown in FIG. 1, and performs functions of the terminal device in the foregoing method embodiments. For ease of description, FIG. 15 shows components of the terminal device. As shown in FIG. 15, the terminal device 150 includes a processor, a memory, a control circuit, an antenna, and an input/output apparatus.

The processor is configured to: process a communication protocol and communication data, control an entire terminal device, execute a software program, and process data of the software program, for example, support the terminal device in performing the actions described in the foregoing method embodiments, for example, performing LBT. The memory is configured to store the software program and data. The control circuit is configured to: perform conversion between a baseband signal and a radio frequency signal, and process the radio frequency signal. The control circuit and the antenna also are collectively referred to as a transceiver that is configured to receive and send a radio frequency signal in a form of an electromagnetic wave. For example, under control of the processor and after the LBT succeeds, HARQ information of a plurality of second terminal devices is sent on a channel resource on which the LBT succeeds. The input/output apparatus, such as a touchscreen, a display, or a keyboard, is configured to receive data input by a user, and output data to the user.

After the terminal device is powered on, the processor reads the software program in the memory, explain and execute instructions of the software program, and process the data of the software program. When data is to be sent in a wireless manner, after performing baseband processing on the to-be-sent data, the processor outputs a baseband signal to a radio frequency circuit. After performing radio frequency processing on the baseband signal, the radio frequency circuit sends a radio frequency signal in a form of an electromagnetic wave through the antenna. When data is sent to the terminal device, the radio frequency circuit receives a radio frequency signal through the antenna, converts the radio frequency signal into a baseband signal, and outputs the baseband signal to the processor. The processor converts the baseband signal into data, and processes the data.

FIG. 15 shows one memory and one processor. However, there are a plurality of processors and a plurality of memories. The memory is referred to as a storage medium, a storage device, or the like. The memory is a storage element located on a same chip as the processor, namely, an on-chip storage element, or an independent storage element. This is not limited in this embodiment.

In an optional implementation, the terminal device includes a baseband processor and a central processing unit. The baseband processor is configured to process the communication protocol and the communication data. The central processing unit is configured to control the terminal device, execute the software program, and process the data of the software program. Functions of the baseband processor and the central processing unit are integrated into the processor in FIG. 15. In some embodiments, the baseband processor and the central processing unit are independent processors, and are interconnected by using a technology such as a bus. In some embodiments, the terminal device includes a plurality of baseband processors to adapt to different network standards, the terminal device includes a plurality of central processing units to enhance a processing capability of the terminal device, and all components of the terminal device is connected through various buses. The baseband processor is also referred to as a baseband processing circuit or a baseband processing chip. The central processing unit may also be expressed as a central processing circuit or a central processing chip. A function of processing the communication protocol and the communication data is built in the processor, or is stored in the memory in a form of a software program. The processor executes the software program to implement a baseband processing function.

In this embodiment, the antenna and the control circuit that have receiving and sending functions is considered as a transceiver unit 1501 of the terminal device 150, for example, to support the terminal device in performing the receiving function and the sending function. A processor 1502 having a processing function is considered as a processing unit 1502 of the terminal device 150. As shown in FIG. 15, the terminal device 150 includes the transceiver unit 1501 and the processing unit 1502. The transceiver unit is also referred to as a transceiver, a transceiver machine, a transceiver apparatus, or the like. Optionally, a component that is in the transceiver unit 1501 and that is configured to implement the receiving function is considered as a receiving unit, and a component that is in the transceiver unit 1501 and that is configured to implement the sending function is considered as a sending unit. In other words, the transceiver unit 1501 includes the receiving unit and the sending unit. The receiving unit is also referred to as a receiver, an input port, a receiving circuit, or the like. The sending unit is referred to as a transmitter machine, a transmitter, a transmitting circuit, or the like.

The processor 1502 is configured to execute the instructions stored in the memory to control the transceiver unit 1501 to receive a signal and/or send a signal, to complete functions of the terminal device in the foregoing method embodiments. The processor 1502 implements the functions of the processing module 1402 shown in FIG. 14. For functions, refer to related descriptions of the processing module 1402. Details are not described herein again. The processor 1502 further includes an interface, configured to implement a signal input/output function. In an implementation, the functions of the transceiver unit 1501 is implemented by using a transceiver circuit or a dedicated transceiver chip. The transceiver unit 1501 implements the functions of the transceiver module 1401 shown in FIG. 14. For functions, refer to related descriptions of the transceiver module 1401. Details are not described herein again.

An embodiment further provides a computer-readable storage medium, configured to store computer software instructions that are executed by the processor. The computer software instructions include a program that is executed by the processor.

A person skilled in the art understands that embodiments are provided as a method, a system, or a computer program product. Therefore, embodiments include hardware embodiments, software embodiments, or embodiments with a combination of software and hardware. Moreover, embodiments include a computer program product that is implemented on one or more computer-usable storage media (including but not limited to a magnetic disk memory, a CD-ROM, an optical memory, and the like) that include computer-usable program code.

Embodiments are described with reference to the flowcharts and/or block diagrams of the method, the device (system), and the computer program product. Computer program instructions are used to implement processes and/or blocks in the flowcharts and/or the block diagrams and a combination of a process and/or a block in the flowcharts and/or the block diagrams. These computer program instructions is provided for a general-purpose computer, a dedicated computer, an embedded processor, or a processor of any other programmable data processing device to generate a machine, so that the instructions executed by a computer or a processor of any other programmable data processing device generate an apparatus for implementing a function in one or more processes in the flowcharts and/or in one or more blocks in the block diagrams.

These computer program instructions alternatively are stored in a computer-readable memory that instructs the computer or any other programmable data processing device to generate an artifact that includes an instruction apparatus. The instruction apparatus implements a function in one or more processes in the flowcharts and/or in one or more blocks in the block diagrams.

These computer program instructions alternatively are loaded onto the computer or any other programmable data processing device, so that a series of operations and steps are performed on the computer or any other programmable device, to generate computer-implemented processing. Therefore, the instructions executed on the computer or any other programmable device provide steps for implementing a function in one or more processes in the flowcharts and/or in one or more blocks in the block diagrams.

Embodiments further include modifications and variations without departing from the spirit and scope of the embodiments described herein. Embodiments are intended to cover these modifications and variations of embodiments provided that they fall within the scope defined by the following claims and their equivalent technologies.

1. A hybrid automatic repeat request (HARQ) feedback method, wherein the method comprises:
performing, by a first terminal device, listen before talk (LBT); and
after the LBT succeeds, sending, by the first terminal device, HARQ information of a plurality of second terminal devices on a channel resource on which the LBT succeeds.

2. The method according to claim 1, wherein the HARQ information of the plurality of second terminal devices comprises feedback information corresponding to the plurality of HARQ processes.

3. The method according to claim 1, wherein the method further comprises:
sending, by the first terminal device, an identifier of the first terminal device to the plurality of second terminal devices.

4. The method according to claim 3, wherein the sending, by the first terminal device, HARQ information of the plurality of second terminal devices on the channel resource on which the LBT succeeds comprises:
sending, by the first terminal device, the HARQ information of the plurality of second terminal devices on a feedback channel on which the LBT succeeds, wherein a correspondence exists between the feedback channel and the first terminal device.

5. The method according to claim 4, wherein the feedback channel is determined based on the identifier of the first terminal device.

6. The method according to claim 3, wherein the first terminal device and the plurality of second terminal devices are located in a same terminal device group, and the identifier of the first terminal device comprises one or more of the following identifiers: an identifier of the terminal device group, an identifier of the first terminal device in the terminal device group, or a source node identifier source ID of the first terminal device.

7. A hybrid automatic repeat request (HARQ) feedback apparatus, wherein the apparatus comprises: at least one processor, and one or more memories coupled to the at least one processor and storing programming instructions for execution by the at least one processor to perform operations comprising:
performing listen before talk (LBT); and
after the LBT succeeds, sending HARQ information of a plurality of second terminal devices on a channel resource on which the LBT succeeds.

8. The apparatus according to claim 7, wherein the HARQ information of the plurality of second terminal devices comprises feedback information corresponding to the plurality of HARQ processes.

9. The apparatus according to claim 7, wherein the operations comprise:
sending an identifier of a first terminal device to the plurality of second terminal devices.

10. The apparatus according to claim 9, wherein when sending the HARQ information of the plurality of second terminal devices on the channel resource on which the LBT succeeds, the operations comprise:
sending the HARQ information of the plurality of second terminal devices on a feedback channel on which the LBT succeeds, wherein a correspondence exists between the feedback channel and the first terminal device.

11. The apparatus according to claim 10, wherein the feedback channel is determined based on the identifier of the first terminal device.

12. The apparatus according to claim 9, wherein the first terminal device and the plurality of second terminal devices are located in a same terminal device group, and the identifier of the first terminal device comprises one or more of the following identifiers: an identifier of the terminal device group, an identifier of the first terminal device in the terminal device group, or a source node identifier source ID of the first terminal device.

13. The apparatus according to claim 7, wherein the apparatus is implemented on a chip or a terminal device.

14. A hybrid automatic repeat request (HARQ) feedback apparatus,
wherein the apparatus comprises:
at least one processor, and
one or more memories coupled to the at least one processor and storing programming instructions for execution by the at least one processor to perform operations including:
detecting, on a channel resource, feedback information sent by a first terminal device, wherein the feedback information comprises HARQ information of a plurality of terminal devices comprising a second terminal device; and
determining, based on the feedback information, HARQ information corresponding to the second terminal device.

15. The apparatus according to claim 14, wherein the HARQ information of the second terminal device comprises feedback information corresponding to the plurality of HARQ processes.

16. The apparatus according to claim 14, wherein the operations comprise:
receiving an identifier of the first terminal device.

17. The apparatus according to claim 16, wherein the channel resource is a feedback channel corresponding to the first terminal device.

18. The apparatus according to claim 17, wherein the feedback channel is determined based on the identifier of the first terminal device.

19. The apparatus according to claim 16, wherein the first terminal device and the plurality of terminal devices are located in a same terminal device group, and the identifier of the first terminal device comprises one or more of the following identifiers: an identifier of the terminal device group, an identifier of the first terminal device in the terminal device group, or a source node identifier source ID of the first terminal device.

20. The apparatus according to claim 14, wherein the apparatus is implemented on a chip or a terminal device.
